(19) United States
(12) Patent Application Publication
(10) Pub. No.: US 2015/0271439 A1
(43) Pub. Date: Sep. 24, 2015

(54) SIGNAL PROCESSING DEVICE, IMAGING DEVICE, AND PROGRAM

(71) Applicant: NIKON CORPORATION, Tokyo (JP)

(72) Inventor: Kosuke Okano, Tokyo (JP)

(73) Assignee: NIKON CORPORATION, Tokyo (JP)

(21) Appl. No.: 14/416,452

(22) PCT Filed: Jul. 18, 2013
(86) PCT No.: PCT/JP2013/069490

§ 371 Date: May 29, 2015

(30) Foreign Application Priority Data
Jul. 25, 2012 (JP) 2012-164667
Apr. 25, 2013 (JP) 2013-092850

(51) Int. Cl. H04N 5/911; G10K 11/178; H04N 5/232

(52) U.S. Cl. CPC H04N 5/911; H04N 5/23212; G10K 11/178

(57) ABSTRACT

A signal processing device capable of reducing noise included in an audio signal, including: a conversion unit for converting an audio signal to a frequency domain signal; a subtraction unit for subtracting from a first frequency domain signal corresponding to a period in which the audio signal includes a predetermined type of noise, the frequency domain signal of estimated noise estimated to reduce the predetermined type of noise; a correction signal generation unit for generating based on a second frequency domain signal corresponding to a period in which the audio signal does not include the predetermined type of noise,
a fourth frequency domain signal used to correct a third frequency domain signal obtained when the subtraction unit subtracts the frequency domain signal of the estimated noise from the first frequency domain signal; and an adding unit for adding the fourth frequency domain signal to the third frequency domain signal.

### TECHNICAL FIELD

The present invention relates to a signal processing device, an imaging device and a program.

### BACKGROUND ART

In receipt years, upon capturing video with a camera, noise sound such as the AP sound included in audio signals has been a problem. There is technology for reducing the noise included in such audio signals. As a representative of this noise cancelling technology, there is a spectral subtraction method (for example, refer to Non Patent Document 1).

The technology described in Non Patent Document 1 reduces the stationary noise included in audio signals by way of estimated noise, and in the case of a comparatively stationary noise overlapping in the background of the speaking voice of a person reduces the stationary noise of the background.

Non Patent Document 1: BOLL, S. F. “Suppression of Acoustic Noise in Speech Using Spectral Subtraction,” IEEE TRANSACTION ON ACOUSTICS, SPEECH, AND SIGNAL PROCESSING, vol. ASSP 27, pp. 113 120, APRIL, 1979.

### DISCLOSURE OF THE INVENTION

### Problems to be Solved by the Invention

However, with the technology described in Non Patent Document 1, in a case like reducing non stationary noise (e.g., noise changing in magnitude, noise occurring intermittently, (etc.), a difference arises between the noise actually fixing in the audio signal and the estimated noise, and the degradation of sound or residual of noise may occur due to excessive subtraction or insufficient subtraction of noise.

In other words, with the technology described in Non Patent Document 1, there is a problem in that it may not be possible to appropriately reduce the noise included in audio signals.

The present invention has been made taking such a situation into account, and the object thereof is to provide a signal processing device. Imaging device and program that can appropriate reduce the noise included in audio signals.

### Means for Solving the Problems

The present invention has been made in order to solve the aforementioned problems, and according to a first aspect of the present invention, provides a signal processing device that includes: a conversion unit chat converts an audio signal into a frequency domain signal; a subtraction unit that subtracts a frequency domain signal of estimated noise that was estimated in order to reduce a predetermined noise, from a first frequency domain signal of a period in which the predetermined noise is included in the audio signal; a correction signal generation unit that generates a fourth frequency domain signal for correcting a third frequency domain signal produced by the subtraction unit subtracting the frequency domain signal of the estimated noise from the first frequency domain signal, based on a second frequency domain signal of a period in which the predetermined noise is not included in the audio signal; and an adding unit that adds the fourth frequency domain signal to the third frequency domain signal.

In addition, according to a second aspect of the present invention, an imaging device is provided, which includes the signal processing devices as described above.

Furthermore, according to a third aspect of the present invention, a program is provided, which causes a computer to execute the steps of: converting an audio signal into a frequency domain signal; subtracting, from a first frequency domain signal of a period in which a predetermined noise is included in the audio signal, a frequency domain signal of estimated noise that was estimated, in order to reduce the predetermined noise; generating a fourth frequency domain signal for correcting a third frequency domain signal produced by subtracting the frequency domain signal of estimated noise from the first frequency domain signal, based on a second frequency domain signal of a period in which the predetermined noise is not included in the audio signal; and adding the fourth frequency domain signal to the third frequency domain signal.

According to a fourth aspect of the present invention, a signal processing novice is provided, which includes: a frequency domain conversion unit that converts a first audio signal and a second audio signal inputted into frequency domain signals; a signal processing unit that processes at least one among the first audio signal and the second audio signal converted into frequency domain signals by way of the frequency domain conversion unit; a phase information generation unit that generates third phase information, establishes a relationship between first phase information of the first audio signal inputted and second phase information of the second audio signal inputted as a first relationship, and generates fourth phase information so that a second relationship between, the third phase information and the fourth phase information is included in a predetermined range including the first relationship; and a time domain conversion unit that converts the first audio signal and the second audio signal processed by the signal processing unit into time domain signals, based on at least the third phase information and the fourth phase information generated by the phase information generation unit.

According to a fifth aspect of the present invention, a signal processing device is provided, which includes; a subtraction processing unit, to which a first audio signal and a second audio signal are inputted, and which subtracts a signal indicating a predetermined noise relative to a period in which the predetermined noise is included, from at least one of the first signal and the second signal; and a generation unit that generates a third signal and a fourth signal, and generates the third signal to correct the first signal and the fourth signal to correct the second signal, so that a second relationship that is a relationship between the third signal and the fourth signal is included in a predetermined range including a first relationship, which is a relationship between a signal of a period of the first audio signal not including the predetermined noise and a signal of a period of the second signal not including the predetermined noise.

Furthermore, according to a sixth aspect of the present invention, a program is provided, which causes a computer to execute; a frequency domain conversion step of converting a first audio signal and a second audio signal inputted into frequency domain signals; a signal processing step of processing at least one among the first audio signal and the second audio signal converted into the frequency domain signals; a phase information generation step of generating third phase information, establishing a relationship between first phase information of the first audio signal inputted and second phase information of the second audio signal inputted as a first relationship, and generating fourth phase information so that a second relationship between the third phase information and the fourth phase information is included in a predetermined range including the first relationship; and a time domain conversion step of converting the first audio signal and the second audio signal processed in the signal processing step into time domain signals, based on at least the third phase information and the fourth phase information generated in the phase information generation step.

According to a seventh aspect of the present invention, a program is provided, which causes a computer to execute the steps of: inputting a first audio signal and a second audio signal, and subtracting a signal indicating a predetermined noise relative to a period in which the predetermined noise is included, from at least one of the first signal and the second signal; and generating a third signal and a fourth signal, and generating the third signal to correct the first signal and the fourth signal to correct the second signal, so that a second relationship that, is a relationship between the third signal and the fourth signal is included in a predetermined range including a first relationship, which is a relationship between a signal of a period of the first signal not including the predetermined noise and a signal of a period of the second signal not including the predetermined noise.

According to an eighth aspect, of the present invention, a signal processing device is provided, which includes: a conversion unit that converts an audio signal into a frequency signal; a subtraction unit that subtracts a predetermined frequency signal from a first frequency signal in which at least part of a predetermined noise is included in the audio signal; and a generation unit that generates a third frequency signal to be added to the first frequency signal that was subtracted by the subtraction unit, based on a second frequency signal in which at least part of the predetermined, noise is not included in the audio signal.

According to a ninth aspect of the present invention, a program is provided, which causes a computer to execute the steps of: converting an audio signal into a frequency signal; subtracting a predetermined frequency signal from a first frequency signal is which at least a part of a predetermined noise is included in the audio signal; and generating a third frequency signal to he added to the first frequency signal, that was subtracted by the subtraction unit, based on a second frequency signal in which at least part of the predetermined noise is not included in the audio signal.

According to a tenth aspect of the present invention, a signal processing device is provided, which includes: an input unit that inputs an audio signal; a subtraction unit that, subtracts a predetermined signal from a first audio signal in which at least part of a predetermined noise is included in the audio signal inputted from the input unit; and a generation unit that generates a third audio signal to be added to the first audio signal that was subtracted by the subtraction unit, based on a second audio signal in which at least part of the predetermined noise is not included in the audio signal.

According to an eleventh aspect of the present invention, a program is provided, which causes a computer to execute the steps of: inputting an audio signal; subtracting a predetermined signal, from a first audio signal in which at least part of a predetermined noise is included in the audio signal inputted in the inputting step; and generating a third audio signal to be added to the first audio signal, that was subtracted in the step of subtracting, based on a second audio signal in which at least part of the predetermined noise is not included in the audio signal.

### Effects of the Invention

The present invention can appropriately reduce the noise included in an audio signal,

### BRIEF DESCRIPTION OF THE DRAWINGS

FIG. 1 is an outline block diagram shooing an example of the configuration of a signal processing device according to a first embodiment of the present invention;

FIG. 2 is a graph showing an example of an audio signal;

FIG. 3 provides views illustrating examples of an environmental sound characteristic spectrum and an estimated noise spectrum;

FIG. 4 provides views illustrating an example of noise reduction processing;

FIG. 5 is a flowchart showing an example of noise reduction processing of the first embodiment;

FIG. 6 is an outline block diagram showing an example of the configuration of an imaging device having a sound collecting function;

FIG. 7 is an outline block diagram showing an example of the configuration of a signal processing device according to a second embodiment;

FIG. 8 is an outline block diagram snowing an example of the configuration of a signal processing device according to a third embodiment;

FIG. 9 is an outline block diagram showing an example of the configuration of an imaging device according to a fourth embodiment;

FIG. 10 is an outline block diagram showing an example of the configuration of a signal processing device according to a fifth embodiment or the present invention;

FIG. 11 is an illustrative diagram of an example of noise reduction processing including white noise correction by way of the signal processing device;

FIG. 12 is a flowchart showing an example or noise reduction processing; and

FIG. 13 is an outline block diagram showing an example of the configuration of an imaging device having a sound collecting function.

### PREFERRED MODE FOR CARRYING OUT THE INVENTION

Hereinafter, embodiments of the present invention will be explained by referencing the drawings.

### First Embodiment

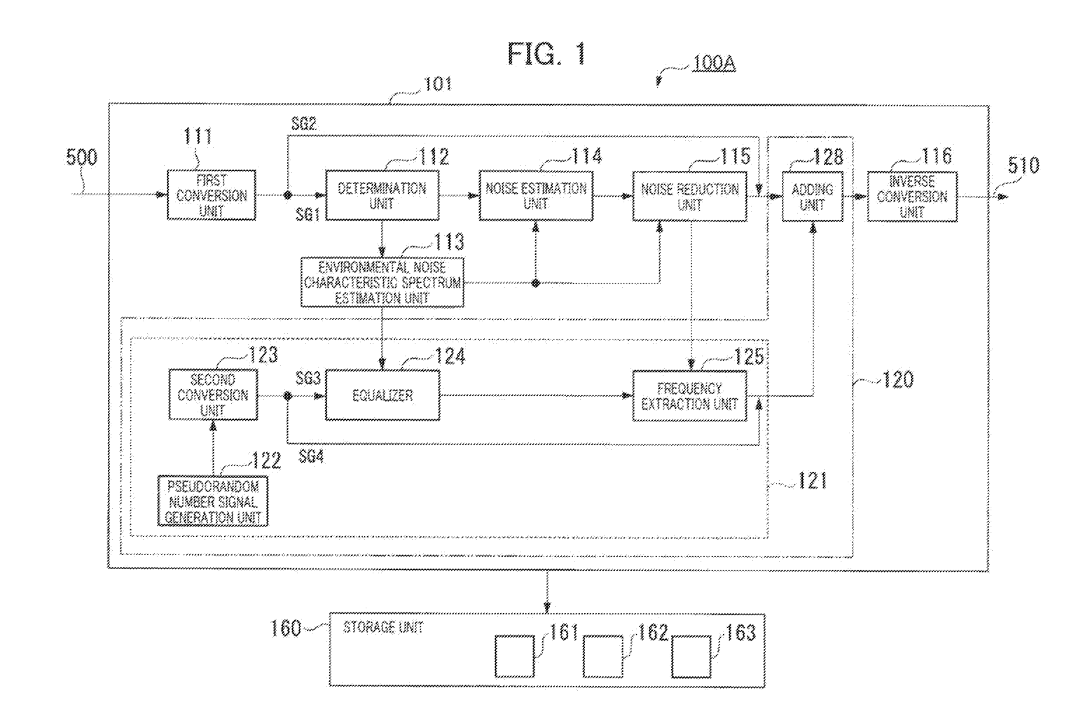

FIG. 1 is an outline block diagram showing an example of the configuration of a signal processing device 100A according to a first embodiment of the present invention. First, an outline of the signal processing device 100A will he explained.

This signal processing device 100A shown in FIG. 1 executes signal processing on an audio signal (reference number 500) inputted, and outputs a processed audio signal (reference number 510). For example, the signal processing device 100A acquires an audio signal recorded in a storage medium, and executes the signal processing on the acquired audio signal.

It should be noted that, in the all embodiments explained hereinafter without limitation to the present embodiment, the storage medium is a peer able medium such as a flash memory card, magnetic disk and optical disk, for example.

It should be noted that the signal processing device 100A may be configured to include a reading unit for reading audio signals from the storage medium internally, or may be configured to include external devices (reading device) that can be connected by wired communication, wireless communication or the like. In addition, in all of the embodiments, it may be configured as a storage device such as USB memory that can be connected via a USB (Universal Serial Bus) connector equipped to the flash memory, or a hard dish in place of the storage medium.

In all of the embodiments, audio signals of recorded sound are stored in the storage medium. For example, audio signals of recorded sound by collecting by way of a device having at least a function of audio collecting are stored in the storage medium. In addition, information indicating a period in which predetermined noise is included or a period in which predetermined noise is not included in she audio signed, of this collected (recorded) sound (alternatively, information capable of determining a period in which predetermined noise is included or a period in which predetermined noise is not included) is recorded in association with this audio signal.

In all of the embodiments, for example, the period in which predetermined noise is included in the audio signal of collected sound may be a period in which an operating unit included in the device collected the sound of this audio signal is operating. On the other hand, the period in which predetermined noise is not included in the audio signal of collected sound may be a period in which the operating unit included in a device recorded the sound of this audio signal is not operating. In addition, information indicating a period in which predetermined noise is included or a period in which predetermined noise is not included in the audio signal of collected sound cap be information indicating the timing at which the operating unit included in the device collected the sound of this audio signal operates.

In all of the embodiments, an operating unit included in the sound collecting device is a configuration in which sound is produced (or there is a possibility of sound being produced; by operating or being operated, among the configurations included in the sound collecting device.

In all of the embodiments, for example, in a case of the sound collecting device being the imaging device, a room lens, lens for vibration reduction (hereinafter referred to an VR (Vibration Reduction) lens), autofocus lens (hereinafter referred to as AF (Auto Focus) lens), operation part, etc. included in this imaging device may be the operating unit. In other words, the predetermined noise in this case is noise in which the sound produced by the sooth lens, VR lens, AF lens, operation part, etc. included in the imaging device operating is collected.

For example, in all of the embodiments, the imaging device drives a drive unit that drives the zoom lens, VR lens or AF lens that is the operating unit, respectively, toy controlling a drive control signal. In other words, the imaging device operates the aforementioned operating unit at the timing of controlling the drive control signal. For example, the imaging device may cause the storage medium to store the information indicating the timing of controlling the drive control signal in association with the audio signal of recorded sound, as information indicating the timing at which the operating unit operates.

It should be noted that the configuration of the imaging device having soon a sound collecting function will, be described later in detail.

The signal processing device 100A executes signal processing on audio signals. For example, the signal processing device 100A executes processing to reduce the noise included in the audio signal, based on the aforementioned such audio signal of recorded sound, and information indicating the timing at which the operating unit operates in association with this audio signal.

Next, the configuration of the signal processing device 100A shown in PIG. 1 will be explained in detail. The signal processing device 100A includes a signal processing unit 101, and a storage unit 160.

The storage unit 160 includes an environmental sound characteristic spectrum storage section 161, a noise storage section 162 and a noise reduction processing information storage section 163.

The environmental sound characteristic spectra to be described later are stored in the environmental sound characteristic spectrum storage section 161. The estimated noise (estimated noise spectrum) to be described later is stored in the noise storage section 162. Information indicating whether processing to reduce a noise component for every frequency component of an audio signal was executed in noise reduction processing is stored to be associated for every frequency component in the noise reduction processing information storage section 163.

The signal processing unit 101 executes signal processing such as noise reduction processing, for example, on an audio signal inputted by reading from the storage medium, and outputs (or causes the storage medium to store) an audio signal produced by executing this signal processing. It should be noted that the signal processing unit 101 may switch between outputting an audio signal produced by executing noise reduction processing on the inputted audio signal, and a signal that is the inputted audio signal as is.

### <Detailed Configuration of Signal Processing Unit 101>

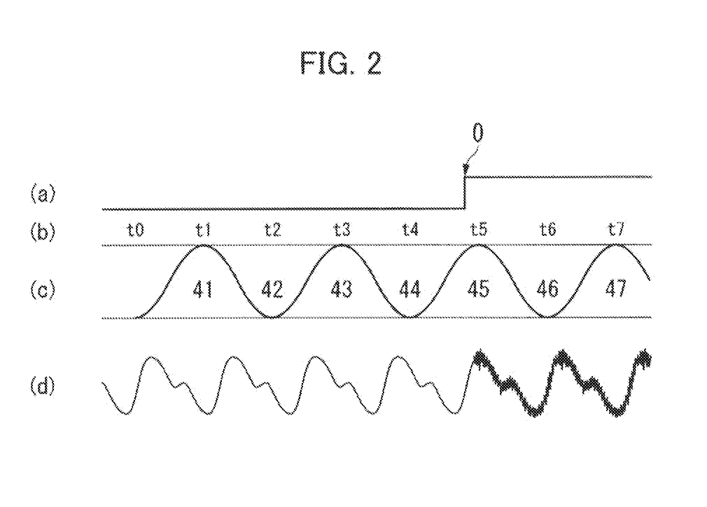

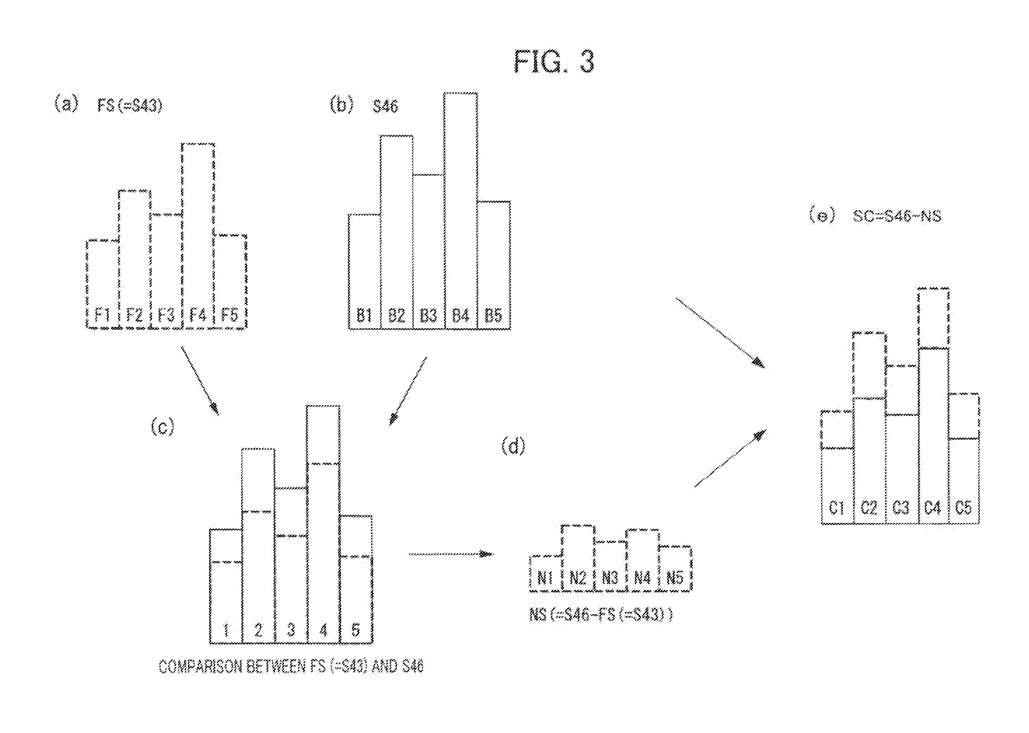

Next, the details of the signal processing unit 101 shown in FIG. 1 will be explained using FIG. 1, FIG. 2 and FIG. 3. The signal processing unit 101 includes a first conversion, unit 111 (conversion unit), a determination unit 112, an evironmental sound characteristic spectrum estimation unit 113, a noise estimation unit 114, a noise reduction unit 115 (subtraction unit), a reverse conversion unit 116 and a sound correction processing unit 120.

Herein, a case of the audio signal (e.g., audio signal collected and recorded by the imaging device) and a signal indicating the timing at which the operating unit operates in association with this audio signal (e.g., an operating unit included in the imaging device) being read from the storage medium and input to the signal processing unit 101 as shown, in FIG. 2 will be explained. It should be noted that the inputted audio signal is an audio signal in which the collected sound has been converted to a digital signal. FIG. 2 shows, from top to bottom, (a) the signal indicating the timing at which the operating unit operates, (b) time, (c) frame number and (d) the waveform of the inputted audio signal.

In FIG. 2, the horizontal axis is the time axis, and the vertical axis is the voltage of various signals, time, or frame number, for example. In addition, as shown in FIG. 2(d), for example, in the case of being an audio signal of when a voice is collected, there are comparatively many repeating signals within a short time on the order of several tens of milliseconds.

In this example of FIG. 2, regarding the relationship between frames and time, the time t0 to t2 corresponds to frame number 41, time t1 to t3 corresponds to frame number 42, time t2 to t4 corresponds to frame renter 43, time t3 to t5 corresponds to frame number 44, time t4 to t6 corresponds to frame number 45, time t5 to t7 corresponds to frame number 46, and time t6 and later corresponds to frame number 47. It should be noted that the time length of each frame is set to be the same.

In addition, this example of FIG. 2 shows (a) the signal indicating the timing at which the operating unit operates transitioning from low level to high level later than time t4 and before time t5 (refer to reference symbol 0 in FIG. 2). It should be noted that, herein, it is established so that low level indicates the operating unit not operating, and high level indicates the operating unit operating. In this way, this example of FIG. 2 shows the operating unit transitioning from a non-operating state to an operating state later than time 4 and before time t5.

Then, in response to such operation of the operating unit, noise is overlapping in (d) the waveform of the inputted audio signal from in the middle of frame numbers 44 and 45 and alter. Herein, when focusing on the relationship between each frame and the noise generation segment, noise is being collected, in frame numbers 44 and later (44, 45, 46, 47 . . . ) due to (a) the signal indicating the timing at which the operating unit operates rising in the middle of frame numbers 44 and 45. In addition, in frame number 46 and after (46, 47 . . . ), noise is being collected in the entire segment of the frame. On the other hand, in frame numbers 43 and earlier (43, 42, 41 . . . ), no noise is being collected.

Herein, the first conversion unit 111 converts the inputted audio signal, to a frequency domain signal. For example, the first conversion unit 111 divides the inputted audio signal into frames, Fourier transforms the audio signal of each divided frame, and generates a frequency spectrum of the audio signal of each frame.

In addition, the first conversion unit 111 may convert to a frequency spectrum after multiplying a window function such as a Hanning window by the audio signal of each frame, in the case of converting the audio signal of each frame into frequency spectra. In addition, the first conversion unit 111 may Fourier transform by way of fast Fourier transform (FFT: Fast Fourier Transforms).

It should be noted that the first conversion unit 111 obtains amplitude information (reference symbol SG1) and phase information (reference symbol SG2) of the frequency components of the audio signal upon generating the frequency spectrum of the inputted audio signal. In addition, the signal processing unit 101 executes noise reduction processing such as that described later on the frequency spectrum of the audio signal for every frame converted by the first conversion unit 111. Then, subsequently, the reverse conversion unit 116 inverse Fourier transforms and outputs the frequency spectrum of each frame subjected to noise reduction processing (frequency spectrum after addition processing of an adding unit 128 to be described later).

It should be noted that the signal processing unit 101 may cause the storage medium to store the audio signal produced by inverse Fourier transforming and outputting.

The determination unit 112 determines whether each frame of the audio signal is a frame of a period in which the operating unit is operating, or a frame of a period in which the operating unit is not operating, based on the timing at which the operating unit operates. In other words, the determination unit 112 determines whether each frame of the audio signal is a frame of a period in which predetermined, noise (e.g., noise produced by the operating unit operating) is included, or is a frame of a period in which the predetermined noise is not included, based on the timing at which the operating unit operates.

It should be noted that the determination unit 112 is not limited to an independent configuration, and may be configured such that the environmental sound characteristic spectrum estimation unit 113 or the noise estimation unit 114 has the functions of the aforementioned determination unit 112.

The environmental sound characteristic spectrum estimation unit 113 estimates the environmental sound characteristic spectrum from the frequency spectrum of the inputted audio signal. Then, the environmental sound characteristic spectrum estimation unit 113 causes the environmental sound characteristic spectrum storage section 161 to store the estimated environmental sound characteristic spectrum. Herein, the environmental sound characteristic spectrum refers to the matter of a frequency spectrum of the audio signal of a period in which the predetermined noise (e.g., noise produced by the operating unit operating) is not included, i.e. a frequency spectrum of the audio signal in which environmental sound of the periphery (ambient sound, target sound) in which the predetermined noise is not included is collected.

For example, the environmental sound characteristic spectrum estimation unit 113 estimates the frequency spectrum of the audio signal (audio signal of environmental sound) in the frames of a period in which the predetermined noise is not included as the environmental sound characteristic spectrum (second frequency domain signal). In other words, the environmental sound characteristic spectrum estimation unit 113 estimates the frequency spectrum of the audio signal in the frames of a period in which the operating unit is not operating as the environmental sound characteristic spectrum. More specifically, for example, the environmental sound characteristic spectrum estimation unit 113 estimates the frequency spectrum of the audio signal in an immediately prior frame not including a period of the operating unit operating, that has be determined based on the timing at which the operating unit operates by the determination unit 112, as the environmental sound characteristic spectrum.

In the case of the example or the audio signal shown in FIG. 2, the environmental sound characteristic spectrum estimation unit 113 estimates the frequency spectrum of the audio signal in frame number 43, for example, as the environmental sound characteristic spectrum. Then, the environmental sound characteristic spectrum estimation unit 113 causes the environmental sound characteristic spectrum storage section 161 to store this frequency spectrum of the audio signal in the frame number 43 as the environmental sound characteristic spectrum.

Hereinafter, explanation will be made with the frequency spectrum of the audio signal in frame number 43 (=S43) called the environmental sound characteristic spectrum FS. In addition, explanation will be made with the strength (magnitude of each frequency component) of each frequency bin of the environmental sound characteristic spectrum FS called F1, F2, F3, F4, F5 in order from low frequency to high frequency (refer to FIG. 3(a)). It should be noted that the number of frequency bins can be set according to the resolution of the frequency spectrum required in noise reduction processing.

The noise estimation unit 114 estimates the noise for reducing the predetermined noise (e.g., noise generated by the operating unit operating) from the inputted audio signal. For example, the noise estimation unit 114 estimates the frequency spectrum or noise from the frequency spectrum of the inputted audio signal, based on the timing at which the operating unit operates. Then, the noise estimation unit 114 causes the noise storage section 162 to store the estimated noise.

For example, the noise estimation unit 114 estimates the frequency spectrum of noise based on the frequency spectrum of the audio signal in a frame of a period in which the predetermined noise is included (first frequency domain signal) and the frequency spectrum of the audio signal in a frame of a period in which the predetermined noise is not included. In other words, the noise estimation unit 114 estimates the frequency spectrum of noise based on the frequency spectrum of the audio signal in a frame of a period in which the operating unit is operating, and the frequency spectrum of the audio signal in a frame of a period in which the operating unit is not operating.

More specifically, for example, the noise estimation unit 114 estimates a difference between the frequency spectrum of the audio signal in a frame immediately after the timing at which the operating unit started operation determined based on the timing at which the operating unit operates by the determination unit 112 (and frames in which the operating unit operates extending over the entire period of the frame), and the frequency spectrum (e.g., environmental sound characteristic spectrum FS) or the audio signal in a frame immediately before the timing at which the operating unit starts operation (and frames in which the operating unit is not operating extending over the entire period of the frame), as the frequency spectrum of noise.

In the case of the example of the audio signal shown in FIG. 2, the noise estimation unit 114 subtracts the frequency spectrum of the audio signal in frame number 43 (i.e. environmental sound characteristic spectrum FS) (refer to FIG. 3(a)) from the frequency spectrum S46 of the audio signal in frame number 46 (refer to FIG. 3(b)) in every frequency bin.

It should be noted that an explanation will be made with the frequency spectrum of the audio signal in frame number 46 called frequency spectrum S46 (refer to FIG. 3(b)). In addition, an explanation will be made with the strength of each frequency bin of the frequency spectrum S46 called B1, B2, B3, B4 and B5 in order from low frequency to high frequency (refer to FIG. 3(b)).

Then, the noise estimation unit 114 estimates the frequency spectrum calculated by subtraction as the frequency spectrum of noise (refer to FIG. 3(d)). Then, the noise estimation unit 114 causes the noise storage section 162 to store the estimated noise.

Hereinafter, an explanation will be made with the frequency spectrum of noise estimated by the noise estimation unit 114 called estimated noise spectrum NS. In addition, an explanation will be made with the strength of each frequency bin of the estimated noise spectrum NS called N1, N2, N3, N4 and N5 in order from low frequency to high frequency (refer to FIG. 3(d)).

The signal processing unit 101 can reduce (cancel) noise of the frequency spectrum of the audio signal in frames in which noise is included, by subtracting from the frequency spectrum of a frame in which noise is included (e.g., frame numbers 44, 45, 46, 47 . . . ) with the frequency spectrum of noise obtained in this way (estimated noise spectrum NS) as the estimated noise.

For example, the noise reduction unit 115 subtracts the estimated noise spectrum NS estimated by the noise estimation unit 114 from the frequency spectrum (first frequency domain signal) of a frame in which noise is included (e.g., frame numbers 44, 45, 46, 47 . . . ) in every frequency bin (every frequency component), respectively.

More specifically, for example, the noise reduction unit 115 calculates the frequency spectrum (called frequency spectrum SC) after noise reduction produced by subtracting the estimated noise spectrum NS from the frequency spectrum S46 of the audio signal in frame number 46, based on the following such relational expression. Herein, the strength of each frequency bin of the frequency spectrum SC is called C1, C2, C3, C4 and C5 in order from low frequency to high frequency (refer to FIG. 3(e)).

The relational expression for calculating the strength of each frequency bin of the frequency spectrum SC is expressed as C1=B1 N1, C2=B2 N2, C3=B3 N3, C4=B4 N4 and C5=B5 N5 in order from low frequency to high frequency, for example. It should be noted that the estimated noise spectrum NS may be subtracted using a predetermined subtraction coefficient. In other words, using a coefficient m, for example, the aforementioned relational expression may be established as C1=B1 (N1×m), C2=B2 (N2×m), C3=B3 (N3×m), C4=B4 (N4×m) and C5=B5 (N5×m), in order from low frequency to high frequency.

It should be noted that the noise reduction unit 115 may select whether to subtract the estimated noise spectrum MS for every frequency bin based on the results of comparing between the frequency spectrum of a frame in which noise is included and the environmental sound characteristic spectrum FS for every frequency bin. For example, the noise reduction unit 115 may establish processing of subtracting the estimated noise spectrum NS from the frequency spectrum of a frame in which noise is included, for a frequency bin in which the strength (amplitude) of the frequency spectrum of the frame in which noise is included is greater than the strength of the environmental sound characteristic spectrum. On the other hand, the noise reduction unit 115 may establish processing that does not subtract the estimated noise spectrum NS from the frequency spectrum of a frame in which noise is not included, for frequency bins in which the strength of the frequency spectrum of the frame in which noise is included is no higher than the strength of the environmental sound characteristic spectrum FS.

It should to noted that processing or selecting whether the noise reduction unit 115 subtracts the estimated noise spectrum NS for every frequency bin is not limited to processing of selecting based on the results of comparison between the frequency spectrum of a frame in which noise is included and the environmental sound characteristic spectrum FS for every frequency bin, and may be established as processing of selecting based on other conditions. For example, in the case of the noise reduction unit 115 selecting whether to subtract the estimated noise spectrum NS for every frequency bin, it may select based on the results of comparing between the frequency spectrum of a frame in which noise is contained and the estimated noise spectrum NS, may select based on the magnitude of the estimated noise spectrum NS for every bin, and may select based on the condition of whether to subtract set in advance for every frequency bin. In addition, the noise reduction unit 115 may simply subtract the estimated noise spectrum NS for all of every frequency bin.

In addition, the noise reduction unit 115 may cause the noise reduction processing information storage section 163 to store information indicating whether the estimated noise spectrum NS is subtracted for every frequency bin. It should be noted that the noise reduction unit 115 may cause the noise reduction processing information storage section 163 to store only information indicating the frequency bins for which the estimated noise spectrum KS was subtracted, or may cause the noise reduction processing information storage section 163 to store only information indicating the frequency bins for which the estimated noise spectrum NS was not subtracted.

In this way, the signal processing unit 101 reduces the noise of the audio signal by way of spectral subtraction processing on the audio signal, based on the frequency spectrum of noise (estimated noise spectrum NS).

This spectral subtraction processing is a method for reducing the noise of the audio signal by first converting the audio signal to frequency domain by Fourier transformation, then after subtracting the noise in the frequency domain, performing inverse Fourier transformation. It should be noted that the signal processing unit 101 (inverse conversion unit 116) may perform inverse Fourier transformation according to inverse fast Fourier transformation (IFFT: Inverse Fast Fourier Transform).

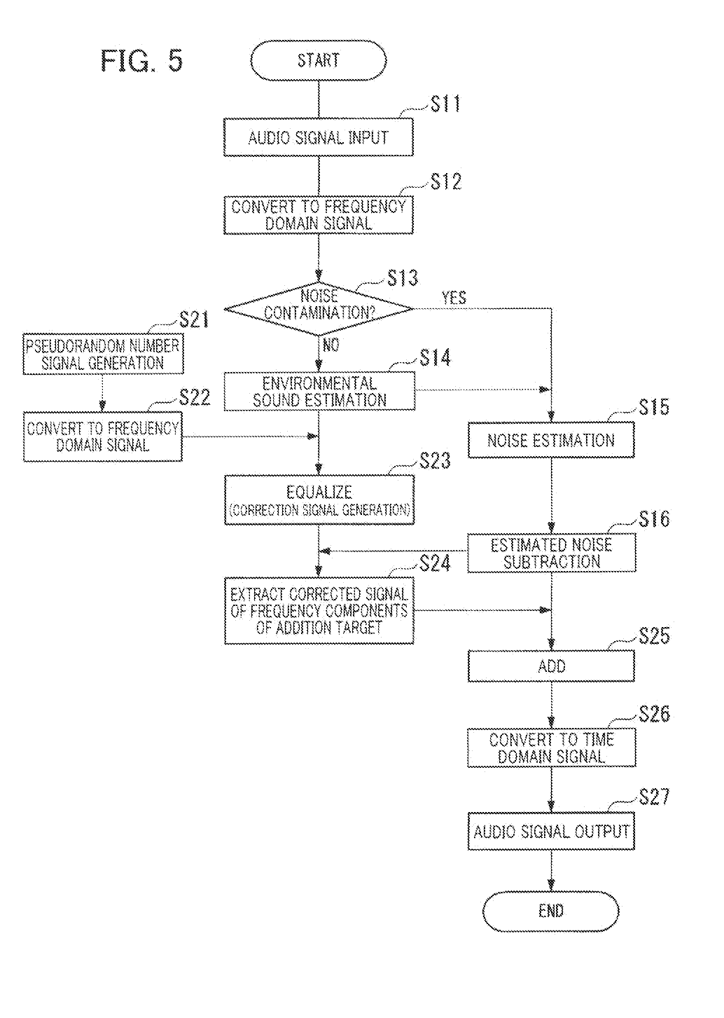

Referring back to the explanation of FIG. 1, each configuration included in the signal processing unit 101 will continue to be explained. In the following explanation, it is configured so that the environmental sound characteristic spectrum FS explained using FIG. 5 and FIG. 3 is estimated by the environmental sound characteristic spectrum estimation unit 113 and stored in the environmental sound characteristic spectrum storage section 160. It should be noted that an environmental sound characteristic spectrum established in advance may be stored in the environmental sound characteristic spectrum storage section 161. In addition, it is configured so that the estimated noise spectrum NS explained using FIG. 2 and FIG. 3 is estimated by the noise estimation unit 114 and stored in the noise storage section 162. It should be noted that estimated noise established in advance may be stored in the noise storage section 162.

As mentioned above, the signal processing device 100A can perform noise reduction processing on audio signals, for example, by subtracting the estimated noise spectrum NS estimated based on the timing at which the operating unit operates from the frequency spectrum of the audio signal in worm noise is included.

However, in the aforementioned such noise reduction processing, in a case like the frequency spectrum of an audio signal other than at least the predetermined noise (e.g., noise produced from the operating unit operating) being included in the estimated noise spectrum NS, the audio signal of environmental noise other than the predetermined noise may be reduced, and thus degradation of the environmental sound, may occur. In addition, in cases like reducing unsteady noise (e.g., noise for which the magnitude varies, noise occurring intermittently, etc.), a difference may arise between the noise actually contaminating the audio signal and the estimated noise, and degradation of the sound may occur from excessive reduction, of the noise. In such a case, audio signals having little strength, of the frequency spectrum tend to degrade more, for example, degradation of an audio signal having a wide frequency band and little strength of the frequency spectrum tends to occur, as in white noise included in the environmental sound (sound important in expressing the ambience of a scene thereof).

Herein, when decreasing the subtracted amount of the estimated noise spectrum NS so that a degradation of environmental sound does not occur, the residue of noise may occur from insufficient subtraction of noise. For this reason, as the subtracted amount, is increased, so as not to insufficiently subtract the predetermined noise, sounds like white noise included in the environmental sound may be further subtracted (reduced), and may become sound with discomfort like sound such as white noise being interrupted only in a frame period on which noise reduction processing was performed.

Therefore, the signal processing device 100A of the present embodiment executes the correction processing shown below in the noise reduction processing. The sound correction processing unit 120 of the signal processing unit 101 corrects environmental sound for which degradation may occur in the noise reduction processing. For example, the sound correction processing unit 120 performs processing to generate a correction signal that corrects the signal of white noise included in the environmental sound for which generation may occur in the noise reduction processing (sound important in expressing the ambience of a scene thereof), and adds the generated correction signal to the audio signal after noise reduction processing.

Next, as example of the configuration of this sound correction processing unit 120 will be explained in detail. The sound correction processing unit 120 includes a correction signal generation unit 121 and an adding unit 128.

The correction signal generation unit 121 includes a pseudorandom number signal generation unit 122, a second conversion unit 123, an equalizer 124 and a frequency extraction unit 125. This correction signal generation unit 121 generates a frequency spectrum (fourth frequency domain signal) of the correction signal based on the pseudorandom number signal and environmental sound characteristic spectrum FS (second frequency domain signal).

The pseudorandom number signal generation unit 122 generates a pseudorandom number signal sequence. For example, the pseudorandom number signal generation unit 122 generates a pseudorandom number signal sequence by way of the linear congruent method, a method using a linear feedback shift register, a method using chaos random numbers, or the like. It should, be noted that the pseudorandom number signal generation unit 122 may generate a pseudorandom number signal sequence using a method other than the aforementioned methods.

The second conversion unit 123 converts the pseudorandom, number signal sequence generated by the pseudorandom number signal generation unit 122 into a frequency domain signal. For example, the second conversion unit 123 divides the pseudorandom number signal sequence into frames, Fourier transforms the pseudorandom number signal of each divided frame, and generates a frequency spectrum of the pseudorandom number signal in each frame.

In addition, the second conversion unit 113 may convert to a frequency spectrum after multiplying a window function such as a Hanning window by the pseudorandom number signal of each frame, in the case of converting the pseudorandom number signal of each frame into frequency spectra. In addition, the second conversion unit 123 may Fourier transform by way of fast Fourier transform (FFT: Fast Fourier Transform). It should be noted that the second conversion unit 123 may be configured as a shared configuration with the first conversion unit 111.

It should be noted that the second conversion unit 123 obtains amplitude information (reference symbol SG3) and phase information (reference symbol SG4) of the frequency components of the pseudorandom number signal upon generating the frequency spectrum of the pseudorandom number signal.

The equalizer 124 generates the frequency spectrum of the correction signal (fourth frequency domain signal) based on the frequency spectrum of the pseudorandom number signal and the environmental sound characteristic spectrum FS. For example, the equalizer 124 generates the frequency spectrum of the correction signal, by equalizing the frequency spectrum of the pseudorandom number signal, using the environmental sound characteristic spectrum FS.

More specifically, the equalizer 124, for example, generates a correction signal, by multiplying the frequency spectrum of the pseudorandom number signal and environmental sound characteristic spectrum FS for every frequency bin, and standardizing (normalising, averaging) so that the sum of the frequency spectra of all frequency bins (sum of amplitudes of all frequency components, or sum of strengths of all frequency components) becomes substantially equal to the sum of the environmental sound characteristic spectra FS (sum of spectra of all frequency bins).

For example, the equalizer 124 may calculate the correction signal according to the mathematical formula 1 shown next.

$$SE\_amp ( k ) = RN\_amp ( k ) \times FS ( k ) \text{/} \{ {\sum }_{k} ( RN\_amp ( k ) ) \text{/} k \} \qquad ( Mathematical formula 1 )$$

SE_amp(k): Frequency spectrum of correction signal

RN_amp(k): Frequency spectrum of pseudorandom number signal

FS(k): Environmental noise characteristic spectrum

k: Frequency bin number (frequency component number)

The frequency extraction unit 125 selects a frequency bin to add in the adding unit 128, and extracts the frequency spectrum of a selected frequency bin, among the frequency spectra of the correction signal generated by the equalizer. For example, the frequency extraction unit 125 selects a frequency bin to add in the adding unit 128 based on the information of every frequency bin indicating whether the noise reduction unit 115 subtracted the estimated noise spectrum NS. In other words, the frequency extraction unit 125 extracts the frequency spectrum of the correction signal of the frequency bin to be added in the adding unit 123, based on the information of every frequency bin indicating whether the noise reduction unit 115 subtracted the estimated noise spectrum NS.

It should be noted that the frequency extraction unit 125 may acquire information of every frequency bin indicating whether the estimated noise spectrum NS was subtracted, by referencing the noise reduction processing information storage section 163.

In addition, for example, the frequency extraction unit 125 extracts the frequency spectrum of the correction signal as an addition target for the frequency bins for which the estimated noise spectrum NS was subtracted, and does not extract the frequency spectrum of the correction signal as the addition target, for frequency bins for which the estimated noise spectrum NS has not been subtracted.

It should be noted that the frequency extraction unit 125 may multiply a factor “1” by the frequency spectrum of the correction signal of the frequency bin serving as the addition target, based on the information for every frequency bin indicating whether the estimated noise spectrum NS was subtracted, and may multiply the factor “0” by the frequency spectrum of the correction signal for the frequency bin not serving as the addition target. It should be noted that the factor multiplying by the frequency spectrum of the correction signal for she frequency bin serving as the addition target may be other than “d”. On the other hand, the factor multiplying by the frequency spectrum of the correction signal for the frequency bin not serving as the addition target may be other than “0”. For example, so long as the factor for the case serving as the addition target is greater than the factor for the case not serving as the addition target, the factor for the case serving as the addition, target may be a factor larger or a factor smaller than “1”, and the factor for the case not serving as the addition target may be a factor greater than “0”.

The adding unit 128 adds the frequency spectrum of the correction signal generated by the equalizer 124 (fourth frequency domain signal) to the frequency spectrum of the audio signal after subtract log the estimated noise spectrum NS from the noise reduction unit 115 (third frequency domain signal).

For example, the adding unit 128 adds the frequency spectrum of the correction signal for the frequency bin established as the addition target by the frequency extraction unit 125. In other words, the adding unit 128 adds the frequency spectrum of the correction signal (fourth frequency domain signal) to the frequency spectrum of the audio signal arrived at after subtracting the estimated noise spectrum NS therefrom (third frequency domain signal), for the frequency bin not subtracted upon the noise reduction unit 115 subtracting the estimated noise spectrum NS from the frequency spectrum of the audio signal (first frequency domain signal) for every frequency bin.

On the other hand, the adding unit 128 reduces the addition amount of the frequency spectrum of the correction signal (fourth frequency domain signal) adding to the frequency spectrum of the audio signal arrived at after subtracting the estimated noise spectrum NS therefrom (third frequency domain signal), for the frequency bin not subtracted, upon the noise reduction unit 115 subtracting the estimated noise spectrum NS from the frequency spectrum of the audio signal (first frequency domain signal) for every frequency bin (e.g., sets the addition amount to “0”, i.e. does not add).

It should be noted that the adding unit 128 may reduce the addition amount of the frequency spectrum of the correction signal (fourth frequency domain signal) adding to the frequency spectrum of the audio signal arrived at after having subtracted the estimated noise spectrum NS therefrom (third frequency domain signal), for the frequency bin for which one subtraction amount was small upon the noise reduction unit 115 subtracting the estimated noise spectrum NS from the frequency spectrum of the audio signal (first frequency domain signal) for every frequency bin.

For example, the adding unit 12% may change the addition amount of the frequency spectrum of the correction signal (fourth frequency domain signal) to differ for every frequency bin, depending on the subtracted amount of every frequency bin by the noise reduction, unit 115. In other words, in the case of the subtracted amount for every frequency bin by the noise reduction unit 115 being large, the adding unit 128 may increase the addition amount of the frequency spectrum of the correction signal for this frequency bin, and in the case of the subtracted amount for every frequency bin by the noise reduction unit 115 being small, may decrease the addition amount of the frequency spectrum of the correction signal for this frequency bin.

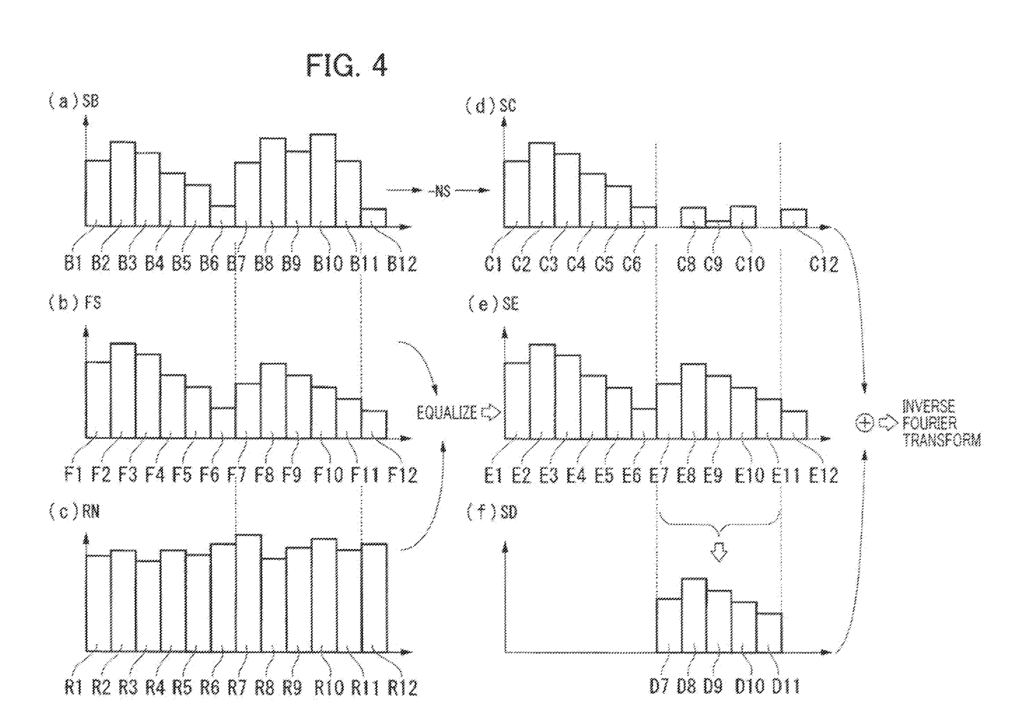

FIG. 4 provides views illustrating an example of noise reduction processing of the first embodiment. Next, an example of noise reduction processing that includes correction processing to add the aforementioned correction signal will be explained by referencing FIG. 4. The frequency spectra shown in FIG. 4 are established to include twelve frequency bins. In addition, the same reference symbols are appended to configurations corresponding to the respective parts in FIG. 2 and FIG. 3.

The frequency spectrum SB shown in FIG. 4(a) is a frequency spectrum of the audio signal converted by the first conversion unit 111, and is a frequency spectrum S46 of frame number 46 in a period in which predetermined noise is included. The strength of each frequency bin m the frequency spectrum SB shown in this drawing are called B1, B2, B3, B4, B5, B6, B7, B8, B9, B10, B11 and B12, in order from low frequency to high frequency.

The frequency spectrum shown in FIG. 4(b) is the environmental sound characteristic spectrum PS, and is the frequency spec trust S43 of frame number 43 for a period in which predetermined noise is not included. The strength of each frequency bin of the environmental sound characteristic spectrum FS shown in this drawing is called F1, F2, F3, F4, F5, F6, F7, F8, F9, F10, E11 and F12 in order from low frequency to high frequency.

The frequency spectrum shown in FIG. 4(c) is a frequency spectrum RN of the pseudorandom number signal produced by the second conversion unit 123 converting the pseudorandom number signal sequence generated by the pseudorandom number signal generation unit 122. The strength of each frequency bin of the frequency spectrum RN of the pseudorandom number signal shown in this drawing is called R1, R2, R3, R4, R5, R6, R7, R8, R9, R10, R11 and R12 in order from low frequency to high frequency.

The equalizer 124 generates the frequency spectrum of the correction signal (hereinafter called frequency spectrum SE of correction signal) by equalizing the frequency spectrum RN of the pseudorandom number signal using the environmental sound characteristic spectrum FS. An example of the frequency spectrum SE of the correction signal generated by this equalizer 124 is shown in FIG. 4(e). The strength of each frequency bin of the frequency spectrum SE of the correction signal shown in this drawing is called E1, E2, E3, E4, E5, E6, E7, E8, E9, E10, E11 and E12 in order from low frequency to high frequency.

The equalizer 124 calculates the strength for every frequency bin of the frequency spectrum SE of the correction signal, by equalizing the frequency spectrum RN of the pseudorandom number signal using the environmental sound characteristic spectrum FS. It should be noted that the equalizer 124 calculates the strength of each frequency bin of the frequency spectrum SE of the correction signal, using the relational expression above in the aforementioned mathematical formula 1, for example. It should be noted that “FS(k)” shown in mathematical formula 1 corresponds to the strengths F1, F2, F3, F4, F5, F6, F7, F8, F9, F10, F11 and F12 of each frequency bin of the environmental sound characteristic spectrum FS shown in FIG. 4(a). In addition, “RN_amp(k)” shown in mathematical formula 1 corresponds to the strengths R1, R2, R3, R4, R5, R6, R7, R8, R9, R10, R11 and R12 of the frequency spectrum RN of the pseudorandom number signal shown in FIG. 4(c). In addition, “SE_amp(k)” shown in mathematical formula 1 corresponds to the strengths E1, E2, E3, E4, E5, E6, E7, E8, E9, E10, E11 and E12 of each frequency bin of the frequency spectrum SE of the correction signal shown in FIG. 4(e).

On the other hand, the frequency spectrum shown in FIG. 4(d) is the frequency spectrum SC of the audio signal arrived at after the processing to subtract the estimated noise spectrum NS from the frequency spectrum SB of the audio signal shown in FIG. 4(a) is executed by the noise reduction unit 115. The strength of each frequency bin of the frequency spectrum SC shown in this drawing is called C1, C2, C3, C4, C5, C6, C7, C8, C9, C10, C11 and C12 in order from low frequency to high frequency.

The noise reduction unit 115 generates the frequency spectrum SC by subtracting the estimated noise spectrum NS from the frequency spectrum SB shown in FIG. 4(a). Herein, the noise reduction unit 115 compares between the frequency spectrum SB and the environmental sound characteristic spectrum FS for every frequency bin, and establishes processing that does not subtract the estimated noise spectrum NS for a frequency bin in which the strength of the frequency spectrum SB is greater than the strength of the environmental sound characteristic spectrum FS. In other words, the noise reduction unit 115 establishes processing that subtracts the estimated noise spectrum NS only fox the frequency bins for which the strength of the frequency spectrum SB is no more than the strength of the environmental sound characteristic spectrum FS (in FIG. 4, frequency bin numbers 7, 8, 9, 10 and 11).

For example, in the case of defining the strength of each frequency bin of the estimated noise spectrum NS as N1, N2, N3, N4, N5, N6, N7, N8, N9, N10, N11 and N12 in order from low frequency to high frequency, the noise reduction unit 115 subtracts the strengths N7, N8, N9, N10 and N11 of each frequency bin for the frequency bin numbers 7, 8, 9, 10 and 11 of the estimated noise spectrum NS, respectively.

In other words, the relational expressions whereby the noise reduction unit 115 calculates the strength of each frequency bin of the frequency spectrum SC, in the aforementioned example, for example, are shown as C1=B1, C2=B2, C3=B3, C4=B4, C5=B5, C6=B6, C7=B7 N7, C8=B8 N8, C9=B9 N9, C10=B10 N10, C11=B11 N11 and C12=B12 in order from low frequency to high frequency.

The frequency spectrum shown in FIG. 4(f) is a frequency spectrum SD of the frequency bins extracted by the frequency extraction unit 125 as the addition target of the adding unit 128, from among the frequency spectrum SE of the correction signal shown in FIG. 4(e). In this example of FIG. 4(f), the frequency extraction unit 125 establishes only the frequency bins subtracted by the noise reduction unit 115 (frequency bin numbers 7, 8, 9, 10 and 11) as addition targets. The strengths of each frequency bin of the frequency spectrum SD of the correction signal serving as the addition target shown in this drawing are called D7, D8, D9, D10 and D11 in order of frequency bin numbers 7, 8, 9, 10 and 11.

The adding unit 128 adds the frequency spectrum SD shown in FIG. 4(f) to the frequency spectrum SC shown in FIG. 4(d). In other words, the adding unit 128 adds the frequency spectrum SD serving as the correction signal for correcting the audio signal having degraded due to subtraction processing, to the frequency spectrum SC produced by the noise reduction unit 115 subtracting the estimated noise spectrum NS from the frequency spectrum SB of the audio signal shown in FIG. 4(a). Then, the signal processing unit 101 generates an audio signal of time domain after noise reduction processing, by adding the frequency spectrum SD to the frequency spectrum SC, as well so inverse Fourier transforming in the inverse conversion unit 116.

In this way, the signal processing device 100A subtracts the estimated noise spectrum NS from the frequency spectrum of the audio signal, as well as adding the frequency spectrum SE of the correction signal (frequency spectrum SD) generated by equalizing the frequency spectrum RN of the pseudorandom number signal using the environmental sound characteristic spectrum FS.

Even in a case of the audio signal other than the predetermined noise also being reduced upon subtracting the predetermined noise from the audio signal, the signal processing device 100A can thereby generate and add an audio signal serving as a replacement for this sound other than the predetermined noise. For example, upon subtracting predetermined noise from the audio signal, even in a case of the audio signal like white noise included in the environmental sound other than the predetermined noise also being reduced, the signal processing device 100A can generate an audio signal serving as a replacement of this audio signal like white noise from the pseudorandom number signal and add thereto.

Consequently, the signal processing device 100A can suppress degradation of the sound occurring due to the audio signal other than the predetermined noise also being reduced (due to excessive reduction of noise). In addition, the signal processing device 100A can suppress the residue of noise occurring due to suppressing from becoming insufficient subtraction of noise by worrying over the audio signal other than the predetermined noise also being reduced.

In other words, the signal processing device 100A can appropriately reduce the noise included in the audio signal.

In addition, the signal processing device 100A adds, only to the frequency spectrum of the frequency bin in which the estimated noise spectrum NS was subtracted from among the frequency spectra of the audio signal, the frequency spectrum SD corresponding to this subtracted frequency bin among the frequency spectrum SE of the generated correction signal. The signal processing device 100A can thereby generate a correction signal (audio signal serving as replacement for the audio signal other than the predetermined noise) and add to only the frequency bin (frequency component) in which the predetermined noise is subtracted from the audio signal. Consequently, the signal processing device 100A can add the correction signal appropriately only for the frequency bins requiring correction, without adding the correction signal for frequency bins not requiring correction.

Hereinafter, different examples of the aforementioned first embodiment will be explained referencing FIGS. 1 to 4.

### (Method of Estimating Environmental Sound Characteristic Spectrum)

In the explanations using the aforementioned FIGS. 2 and 3, explanations are given with the environmental sound characteristic spectrum estimation unit 113 estimating the frequency spectrum of the audio signal in frame number 43 as the environmental sound characteristic spectrum FS. However, the method of estimating the environmental sound characteristic spectrum by way of the environmental sound characteristic spectrum estimation unit 113 is not limited thereto.

For example, the environmental sound characteristic spectrum estimation unit 113 may estimate the frequency spectrum arrived at by averaging each of the frequency spectra of the audio signal in a plurality of frames prior to the timing at which the operating unit operates, based on the timing at which the operating unit operates, for every frequency bin as the environmental sound characteristic spectrum FS.

In addition, the environmental sound characteristic spectrum estimation unit 113 may calculate weighted averages in the case of averaging a plurality of frequency spectra for every frequency bin. This weighted value may be made lighter as moving away from the frame of the audio signal serving as the target of environmental sound characteristic processing (starting frame).

In addition, the environmental sound characteristic spectrum estimation unit 113 may estimate, as the environmental sound characteristic spectrum FS, a frequency spectrum that assumes the maximum or minimum for each frequency spectrum of the audio signal for every frequency bin among the plurality of frames prior to the timing at which the operating unit operates, based on the timing at which the operating unit operates.

In addition, the environmental sound characteristic spectrum estimation unit 111 may estimate, as the environmental sound characteristic spectrum FS, a frequency spectrum of the audio signal of a frame after the timing at which the operating unit operates, based on the timing at which the operating unit operates. In addition, the environmental sound characteristic spectrum estimation unit 113 may estimate the environmental sound characteristic spectrum FS, based on the frequency spectrum of the audio signal in a plurality of frames after the timing at which the operating unit operates.

It should be noted that, when estimating the environmental sound characteristic spectrum FS, it is preferable for the environmental sound characteristic spectrum estimation unit 113 to estimate the environmental sound characteristic spectrum FS, based at least on the frame after the frame of the timing at which operating unit operates immediately prior. This is because, as the environmental sound characteristic spectrum FS, a frequency spectrum for the audio signal or a frame in which the operating unit is not operating is preferable. In addition, this is because, as the frame of the audio signal generating the environmental audio characteristic spectrum FS temporally becomes more distant from the audio signal serving as the target of environmental sound characteristic processing, the suitability as the environmental sound characteristic spectrum FS relative to this audio signal decreases.

In addition, the environmental sound characteristic spectrum FS may be stored in advance in the environmental sound characteristic spectrum storage section 161. For example, the environmental sound characteristic spectrum FS according to each case may be stored in advance in the environmental sound characteristic spectrum storage section 161 in association with environmental information indicating the situation of the sound of the surroundings in the case of a sound collecting device (e.g., imaging device) collecting sound (recording), or photographing mode information indicating the photographing mode. Then, the signal processing unit 101 may read the environmental sound characteristic spectrum FS associated with the environmental information or photography mode selected by the user from the environmental sound characteristic spectrum storage section 161, and execute the noise reduction processing explained in the aforementioned explanations of FIG. 2, 3 or 4, based on this read environmental sound characteristic spectrum FS.

In addition, in the case of causing the signal on which to perform noise reduction processing to be stored in volatile memory (not illustrated) or the like, it becomes possible to calculate the environmental sound characteristic spectrum FS based on the information after generating noise has vanished.

### (Processing on Frame Number 47 and Later in FIG. 2)

A case of the signal processing unit 110 performing noise reduction processing on the audio signal of frame number 46 has been explained in the explanation using the aforementioned FIGS. 2 to 4. This signal processing unit 101 can noise reduction process also on the audio signal of frame number 47 and later, which are audio signals later than frame number 48, similarly to the case of the audio signal of frame number 46.

### (Estimation of Noise)

In addition, in the explanation using the aforementioned FIGS. 2 to 4, the noise estimation unit 114 was explained as estimating the frequency spectrum of noise by subtracting the frequency spectrum of the audio signal of frame number 43 (i.e. environmental sound characteristic spectrum FS) (refer to FIG. 3(a)) from the frequency spectrum S46 of the audio signal of frame number 46 for every frequency bin (refer to FIG. 3(b). However, the method of the noise estimation unit 114 estimating the frequency spectrum of noise is not limited thereto.

First, the noise estimation unit 114 can use the environmental sound characteristic spectrum FS estimated by any method for a case of the environmental sound characteristic spectrum estimation unit 113 explained above estimating the environmental sound characteristic spectrum FS, in place of the environmental sound characteristic spectrum FS that is the frequency spectrum of the audio signal of frame number 43.

In addition, the noise estimation unit 114 may use the frequency spectrum arrived at by averaging the frequency spectra of the audio signals for a plurality of frames at timings at which the operating unit is operating, for every frequency bin, based on the timing at which the operating unit operates as detected by the timing detection unit 91, in place of the frequency spectrum S46 of the audio signal for frame number 46. For example, the noise estimation unit 114 may use a frequency spectrum arrived at by averaging the frequency spectrum of the audio signal for a plurality of frames like frames 46 and 47 for every frequency bin, in place of the frequency spectrum S46 of the audio signal for frame number 46.

In addition, the noise estimation unit 114 may calculate an average with weighting in the case of averaging a plurality of frequency spectra for every frequency bin. The value of this weight may be made lighter as moving away from the frame of the audio signal serving as the target of environmental sound characteristic processing (start frame). In addition, the noise estimation unit 114 may use a frequency spectrum that assumes the maximum or minimum for every frequency bin of the frequency spectra of a plurality of frames at the timing at which the operating unit is operating, in place of the frequency spectrum S46. It should be noted that, similarly to a case of the environmental sound characteristic spectrum FS, the frequency spectrum of noise may be stored in advance in the noise storage section 162.

### (Equalizing of Pseudorandom Number Signal)

In addition, in the explanation of the aforementioned FIG. 4, the equalizer 124 was explained as equalizing the frequency spectrum RN of the pseudorandom number signal using the frequently spectrum of the audio signal for frame number 43 (i.e. environmental sound characteristic spectrum FS). However, the method of the equalizer 124 equalizing the frequency spectrum RN of the pseudorandom number signal is not limited thereto.

For example, the equalizer 114 can use the environmental sound characteristic spectrum FS estimated by any method for a case of the environmental sound characteristic spectrum estimation unit 113 explained above estimating the environmental sound characteristic spectrum FS, in place of the environmental sound characteristic spectrum FS that is the frequency spectrum of the audio signal for frame number 43.

In other words, the equalizer 124 may equalise the frequency spectrum RN of the pseudorandom number signal using the environmental sound characteristic spectrum FS made with the average value, maximum or minimum for every frequency bin among the frequency spectra of a plurality of frames prior to the timing at which the operating unit operates. In addition, the equalizer 124 may equalize the frequency spectrum RN of the pseudorandom number signal using the environmental sound characteristic spectrum FS estimated based on the frequency spectrum of a frame after the timing at which the operating unit operates. For example, the equalizer 124 may equalise the frequency spectrum RN of the pseudorandom number signal, using the environmental sound characteristic spectrum FS made with the average value, maximum or minimum for every frequency bin of the frequency spectrum of a plurality of frames after the timing at which the operating unit operates. In addition, the equalizer 124 may equalise the frequency spectrum RN of the pseudorandom number signal using an environmental sound characteristic spectrum FS established in the advance.

### (Operations of Noise Reduction Processing)

Next, the operations of noise reduction processing of the first embodiment will be explained by referencing FIG. 5. FIG. 5 is a flowchart showing an example of the noise reduction processing of the first embodiment.

First, the signal processing unit 101 reads the audio signal from the storage medium. The read audio signal is inputted to the first conversion unit 111 of the signal processing unit 101 (Step S11).

Next, the first conversion unit 111 converts the inputted audio signal into a frequency domain signal. For example, the first conversion unit 111 divides the inputted audio signal into frames, Fourier transforms the audio signal of each divided frame, and generates the frequency spectrum of the audio signal for each frame (Step S12).

Next, the determination unit 112 determines whether each frame of the audio signal is a frame of a period in which the operating unit is operating, or a frame of a period in which the operating unit is not operating, based on the timing at which the operating unit operates. In other words, the determination unit 112 determines whether each frame of the audio signal is a frame of a period in which the predetermined noise (e.g., noise produced from the operating unit operating) is included (whether the predetermined noise is contaminating), based on the timing at which the operating unit operates (Step S13).

The environmental sound characteristic spectrum estimation unit 113 estimates the environmental sound characteristic spectrum FS (frequency spectrum of environmental sound, refer to FIG 4(b)) based on the frequency spectrum of the audio signal of a frame for which it was determined to be a frame of a period in which the predetermined noise is not included (Step S13: NO), from among the respective frames of the inputted audio signal (Step S14).

On the other hand, the noise estimation unit 114 estimates the frequency spectrum of noise (estimated noise spectrum NS) based on the frequency spectrum SB (refer to FIG. 4(a)) of the audio signal of a frame for which it was determined to be a frame of a period in which the predetermined noise is included (Step S13: YES), from among the respective frames of the inputted audio signal, and the environmental sound characteristic spectrum FS. For example, the noise estimation unit 114 generates the estimated noise spectrum NS by subtracting the environmental sound characteristic spectrum FS from the frequency spectrum SB of the audio signal for the frame of a period in which the predetermined noise is included, for every frequency bin (Step S15).

Next, for every frequency bin (every frequency component), the noise reduction unit 115 subtracts the estimated noise spectrum NS estimated by the noise estimation unit 114 from the frequency spectrum SB (Step S16). For example, the noise reduction unit 115 compares between the frequency spectrum SB and the environmental sound characteristic spectrum FS for every frequency bin, and subtracts the estimated noise spectrum NS only for the frequency bins in which the strength of the frequency spectrum SB is no higher than the strength of the environmental sound characteristic spectrum FS (refer to FIG. 4(d)).

On the other hand, the pseudorandom number signal generation unit 122 generates a pseudorandom number signal sequence (Step S21). Next, the second conversion unit 123 converts the pseudorandom number signal sequence generated by the pseudorandom number signal generation unit 122 into a frequency domain signal. For example, the first conversion unit 111 divides the pseudorandom number signal sequence into frames. Fourier transforms the pseudorandom number signal of each divided frame, and generates a frequency spectrum RN (refer to FIG. 4(c)) of the pseudorandom number signal for each frame (Step S22).

Next, the equalizer 124 generates the frequency spectrum SE of the correction signal (refer to FIG. 4(e)) by equalizing the frequency spectrum RN of the pseudorandom number signal using the environmental sound characteristic spectrum FS (Step S23).

In addition, among the frequency spectrum SE of the correction signal, the frequency extraction unit 125 extracts the frequency spectrum SD of a frequency bin serving as the addition target by the adding unit 128. In other words, the frequency extraction unit 125 extracts the frequency spectrum SD of the correction signal for the frequency bins that are the addition targets, from the frequency spectrum SE of the correction signal (Step S24). For example, the frequency extraction unit 125 selects a frequency bin in which the noise reduction unit 115 subtracts the estimated noise spectrum RS in Step S16 as the frequency bin of the addition target, and extracts the frequency spectrum SD of a selected frequency bin.

Then, tire adding unit 128 adds the frequency spectrum SD of the correction signal extracted in Step S24 to the frequency spectrum SC (refer to FIG. 4(d)) produced by the estimated noise spectrum NS being subtracted from the frequency spectrum SB in Step S16 (Step S25).

Next, the inverse conversion unit 115 generates an audio signal of time domain after noise reduction processing, by inverse Fourier transforming the frequency spectrum arrived at by adding the frequency spectrum SD to the frequency spectrum SC (Step S26). Then, the signal processing unit 101 outputs an audio signal of time domain after noise reduction processing (Step S27).

<Configuration Example of Imaging Device having Sound Collecting Function>

Next, an example for the configuration of an imaging device collected the sound of an audio signal stored in the aforementioned storage medium will be explained. The configuration of the imaging device explained hereinafter includes a microphone for collecting sound and the aforementioned operating unit, collects information indicating the timing at which the operating unit operates, and causes the storage medium to store the information in association with the recorded audio signal.

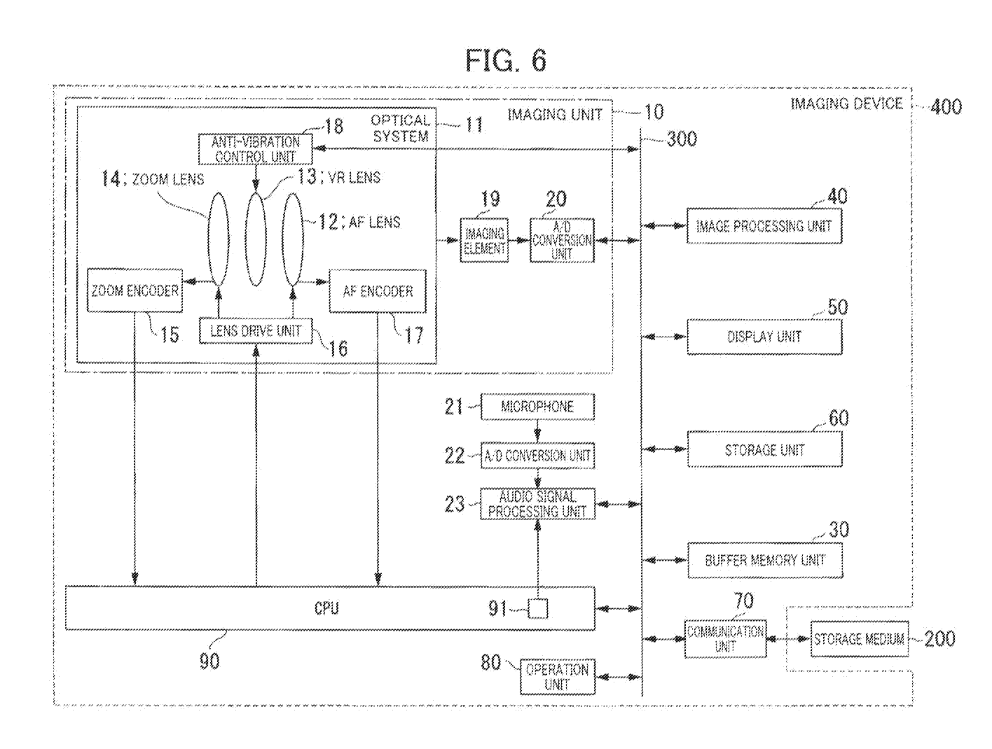

FIG. 6 is an outline block diagram showing an example of the configuration of an imaging device 400 having a sound collecting function. The imaging device 400 in FIG. 6 includes an imaging unit 10, a CPU (Central Processing Unit) 90, an operation unit 80, an image processing unit 40, a display unit 50, a storage unit 60, a buffer memory unit 30, a communication unit 70, a microphone 21, an A/D (Analog/Digital) conversion unit 22, an audio signal processing unit 23, and a bus 300.

The imaging unit 10 includes an optical system 11, an imaging element 19 and an A/D conversion unit 20; is controlled by the CPU 90 along the set photographing conditions (e.g., aperture, exposure, etc.); forms an optical image from the optical system 11 on the imaging element 19; and generates image data based on this optical image converted into a digital signal by the A/D conversion unit 20.

The optical system 11 includes a zoom lens 11, a VR lens 13, an AD lens 12, a zoom encoder 15, a lens drive unit 16, an AF encoder 17, and an anti vibration control unit 18.

This optical system 11 guides the optical image having passed through the zoom lens 14, the VR lens 13 and the AF lens 12 onto a light receiving surface of the imaging element 19.

The lens drive unit 16 controls the position of the zoom lens 14 or the AF lens 12, based on the drive control signal inputted from the CPU so to be described later.

The anti vibration control unit 18 controls the position of the VR lens 13 based on the drive control signal inputted from the CPU 90 to be described later. This anti vibration control unit 18 may detect the position of the VR lens 13.

The zoom encoder 15 detects the zoom position expressing the position of the zoom lens 14, and outputs the detected zoom position to the CPU 90.

The AF encoder 17 detects the focus position expressing the position of the AF lens 12, and outputs the detected focus position to the CPU 90.

It should be noted that the aforementioned optical system 11 may be integrally mounted to the imaging device 400, or may be detachably mounted to the imaging device 400.

The imaging element 19, for example, converts the optical image formed on the light receiving surface into an electronic signal, and outputs to the A/D conversion unit 20.

In addition, the imaging element 19 causes the storage medium 200 to store image data obtained upon accepting a photography instruction from the operation unit 80, via the A/D conversion unit 20 or image processing unit 40, as captured image data of a photographed still image.

On the other hand, the imaging element 18, for example, outputs the image data continuously obtained in a state of not accepting a photography instruction via the operation unit 80, to the CPU 90 and display unit 50 via the A/D conversion unit 20 or image processing unit 40, as through image data.

The A/D conversion unit 20 analog/digital converts the electronic signal converted by the imaging element 19, and outputs image data, which is this converted digital signal.

The operation unit 80, for example, includes a power switch, shutter button, and other operation keys, accepts operation inputs of the user by being operated by the user, and outputs to the CPU 90.

The image processing unit 40 conducts image processing on the image data recorded in the buffer memory unit 30 or the storage medium 200, by referencing the image processing conditions stored in the storage unit 160.

The display unit 50 is a liquid crystal display, for example, and displays image data obtained by the imaging unit 10, an operation screen or the like.

The storage unit 60 stores determination conditions referenced upon scene determination by the CPU 90, photographing conditions, etc.

The microphone 21 collects sound, and converts to an audio signal according to this collected sound. This audio signal is an analog signal.

The A/D conversion unit 22 converts the audio signal that is an analog signal converted by the microphone 21 into an audio signal that is a digital signal.

The audio signal processing unit 23 executes signal processing for storing in the storage medium 200 on the audio signal that is a digital signal converted by the A/D conversion unit 22. In addition, the audio signal processing unit 23 causes the storage medium 200 to store information indicating the timing at which the operating unit operates in association with the audio signal. This information indicating the timing at which the operating unit operates, for example, is information detected by the timing detection unit 91 to be described later.

If should be noted that the audio signal to be stored, in the storage medium 200 by the audio signal processing unit 23 is an audio signal of sound stored in association with video, an audio signal of sound recorded in order to add voices to still images stored in the storage medium 200, an audio signal of sound recorded as a voice recording, or the like.

The buffer memory unit 30 temporarily stores image data captured by the imaging unit 10, audio signals that have been signal processed toy the audio signal processing unit 23, information, etc.

The communication unit 70 is connected with the removable storage medium 200 such as card memory, and writes, reads or erases information on this storage medium 200.

The storage medium 200 is a storage unit that is detachably connected to the imaging device 400, and stores image data generated (recorded) by the imaging unit 10, audio signals that have been signal processed by the audio signal processing unit 23, and information, for example.

The CPU 90 controls the entirety of the imaging device 400; however, as an example, it generates a drive control signal for controlling the positions of the zoom ions 14 and the AF lens 12, based on the zoom position inputted from the zoom encoder 15, and focus position inputted from the AF encoder 17, and operation inputs inputted from the operation unit 80. The CPU 90 controls the positions of the zoom lens 14 and the AF lens 12 via the lens drive unit 16, based on this drive control signal.

In addition, this CPU 90 includes the timing detection unit 91. This timing detection unit 91 detects the timing at which the operating unit included in the imaging device 400 operates.

An operating unit referred to herein is the aforementioned zoom lens 14, the VR lens 13, the AF lens 12 or the operation unit 80 as an example, and has a configuration to produce sound by operating or being operated (or has a possibility of sound producing), among the configurations included in the imaging device 400.

In addition, this operating unit is a configuration for which the sound produced by operating, or sound produced by being operated, is collected by the microphone 21 (or has a possibility of being collected), among the configurations included in the imaging device 400.

This timing detection unit 91 may detect the timing at which the operating unit operates, based on the control signal causing the operating unit to operate. This control signal is a control signal controlling operation of the operating unit, or a drive control signal controlling the drive unit (e.g., the lens drive unit 16, the anti vibration control unit 18) driving the this operating unit (e.g., the zoom lens 14, the VR lens 13, the AF lens 12, etc.).

For example, the timing detection unit 91 may detect the timing at which the operating unit operates, based on the drive control signal inputted to the lens drive unit 16 for driving the room lens 14, the VR lens 13 or the AF lens 12 or the anti vibration control unit 18, or based on the drive control signal generated by the CPU 90.

In addition, in the case of the CPU 90 generating the drive control signal, the timing detection unit 91 may detect the timing at which the operating unit operates based on processing or commands executed inside the CPU 90.

In addition, the timing detection unit 91 may detect the timing at which the operating unit operates, based on a signal indicating that the zoom lens 14 or the AF lens 12 is being driven inputted from the operation unit 90.

In addition, this timing detection unit 91 may defect the timing at which the operating unit operates, based on a signal indicating that the operating unit operated.

For example, the timing detection unit 91 may detect the timing at which the operating unit operates, by detecting that the zoom lens 14 or the AF lens 12 operated, based on the output of the zoom encoder 15 or the AF encoder 17.

In addition, the timing detection unit 91 may detect the timing at which the operating unit operates by detecting that the VR lens 13 operated, based on the output from the anti vibration control unit 18.

In addition, this timing detection unit 91 may detect the timing at which the operating unit operates, by detecting that the operation unit 80 was operated, based on the input from the operation unit 80.

Then, the timing detection unit 91 detects the timing at which the operating unit included in the imaging device 400 operates, and outputs a signal indicating this detected timing to the audio signal processing unit 23.

The bus 300 is connected to the imaging unit 10, CPU 90, an operation unit 80, an image processing unit 40, a display unit 50, a storage unit 160, a buffer memory unit 30, a communication unit 70 and an audio signal processing unit 23, and transmits data, control signals, etc. outputted from every part.

### Second Embodiment

Next, a signal processing device 100B according to a second embodiment will be explained.

In the first embodiment, a method of generating a frequency spectrum of a correction signal by equalizing the frequency spectrum of a generated pseudorandom number signal using the environmental sound characteristic spectrum is explained; however, in the second embodiment, a method of generating the frequency spectrum of the correction signal without generating a pseudorandom number signal will be explained.

In the first embodiment, the phase of the frequency spectrum SE generated by converting the pseudorandom number signal sequence into a frequency domain signal (refer to SG4 in FIG. 1) is a different phase from the phase of the frequency spectrum SC of the audio signal (refer to SG2 in FIG. 1). In other words, a signal processing device 100B generates a frequency spectrum which is a different phase from the phase of the frequency spectrum SC of the audio signal and is a strength (amplitude) equalized by the environmental sound characteristic spectrum FS, as the frequency spectrum of the correction signal for correcting the audio signal of sound such as white noise. For this reason, the signal processing device 100B may generate the frequency spectrum of the correction signal by changing the phase of the environmental Bound characteristic spectrum FS to a different phase, without using the pseudorandom number signal sequence.

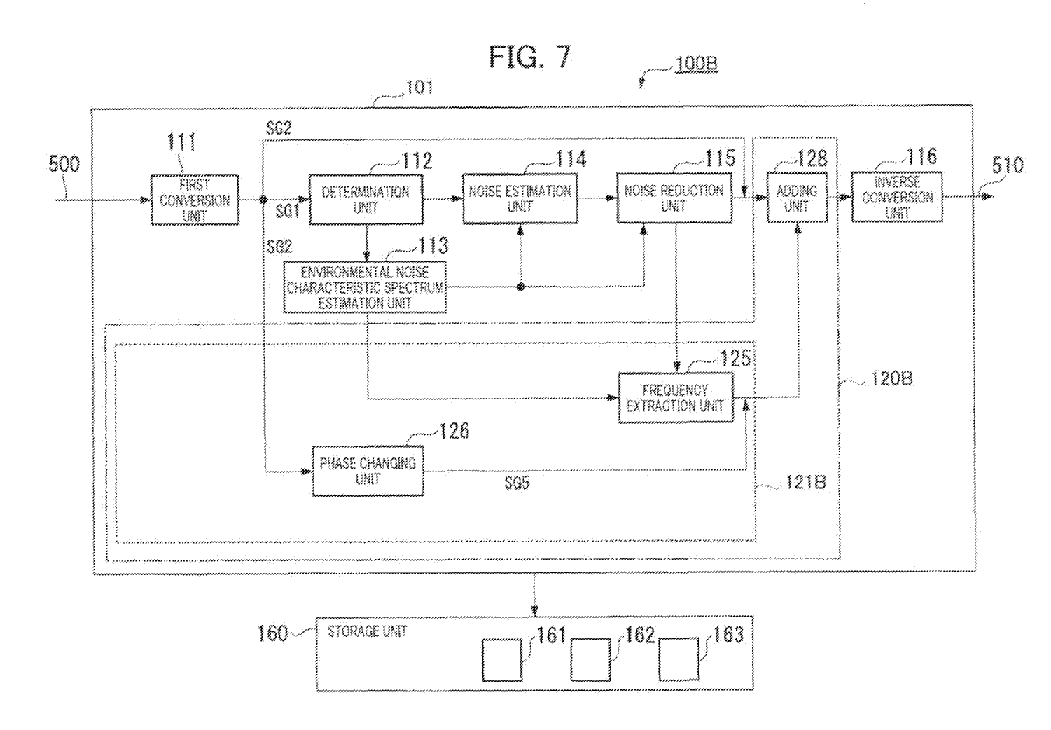

FIG. 7 is an outline block diagram showing an example of the configuration of the signal processing device 100B according to the second embodiment. This configuration of the signal processing device 100B shown in FIG. 7 differs from the configuration shown in FIG. 1 in the configuration of the correction signal generation unit 121. It should be noted that, in FIG. 7, the same reference symbols are appended to configurations corresponding to every part in FIG. 1, and explanations thereof will be omitted.

The correction signal generation unit 121 includes the frequency extraction unit 125 and a phase changing unit 126. The phase changing unit 126 changes the inputted phase (phase information) to a phase difference from this inputted phase, and then outputs the changed phase (phase information). For example, the phase changing unit 126 outputs phase information (reference symbol SG5) of a different phase from the phase expressed by the phase information (reference symbol SG2), based on the phase information (reference symbol SG2) of the frequency spectrum converted by the first conversion unit 111.

The frequency extraction unit 125 extracts the frequency spectrum of the frequency bin serving as the addition target from the environmental sound characteristic spectrum FS estimated by the environmental sound characteristic spectrum estimation unit 113. In other words, the frequency extraction unit 125 extracts the frequency spectrum of the correction signal serving as the addition target from the environmental sound characteristic spectrum FS.

The adding unit 118 adds the frequency spectrum extracted by the frequency extraction unit 128 to the frequency spectrum FC of the audio signal obtained after the noise reduction unit 115 subtracted the estimated noise NS. In other words, the adding unit 128 adds the environmental sound characteristic spectrum FS changed to a different phase from the phase of the frequency spectrum SC of the audio signal, to the frequency spectrum FC.

Then, the inverse conversion unit 116 inverse Fourier transforms and then outputs the frequency spectrum arrived at by adding the frequency spectrum SC of the audio signal and the environmental sound characteristic spectrum FS of different phases from each other.

In this way, the correction signal generation unit 121 generates the spectrum SB of the correction signal, by changing the phase of the environmental sound characteristic spectrum FS to a different phase. In other words, the correction signal generation unit 121 generates a frequency spectrum at least having a different phase relative to the frequency spectrum SB, as the frequency spectrum (frequency spectrum of correction signal) correcting the frequency spectrum FC obtained after subtracting the estimated noise spectrum NS from the frequency spectrum SB of the audio signal in which the predetermined noise is included.

The signal processing device 100B can thereby generate and add a frequency spectrum at least having a different phase relative to the frequency spectrum of the inputted audio signal, as the frequency spectrum (frequency spectrum of correction signal) of the audio signal serving as a replacement for an audio signal like white noise, even in a case of an audio signal like white noise included in the environmental sound other than the predetermined noise also being reduced upon subtracting the predetermined noise from the audio signal. In other words, the signal processing device 100B can generate and add an audio signal serving as a replacement for the audio signal other than predetermined noise, even in a case of the audio signal other than the predetermined noise also being reduced, upon subtracting the predetermined noise from the audio signal. Consequently, the signal processing device 100B can appropriately reduce the noise included in tire audio signal.

### Third Embodiment

Next, a signal processing device 100C according to a third embodiment will be explained.

This third embodiment is another embodiment of a configuration generating a frequency spectrum at least having a different phase relative to the frequency spectrum of the inputted audio signal as the frequency spectrum of the correction signal, as explained in the second embodiment.

In the second embodiment, the frequency spectrum of the correction signal was generated by changing the phase of the environmental sound characteristic spectrum FS to a different phase. In this third embodiment, the frequency spectrum of the correction signal is generated in which a different phase from the phase of the frequency spectrum of the inputted audio signal is established as the phase of the frequency spectrum of a pseudorandom number signal.

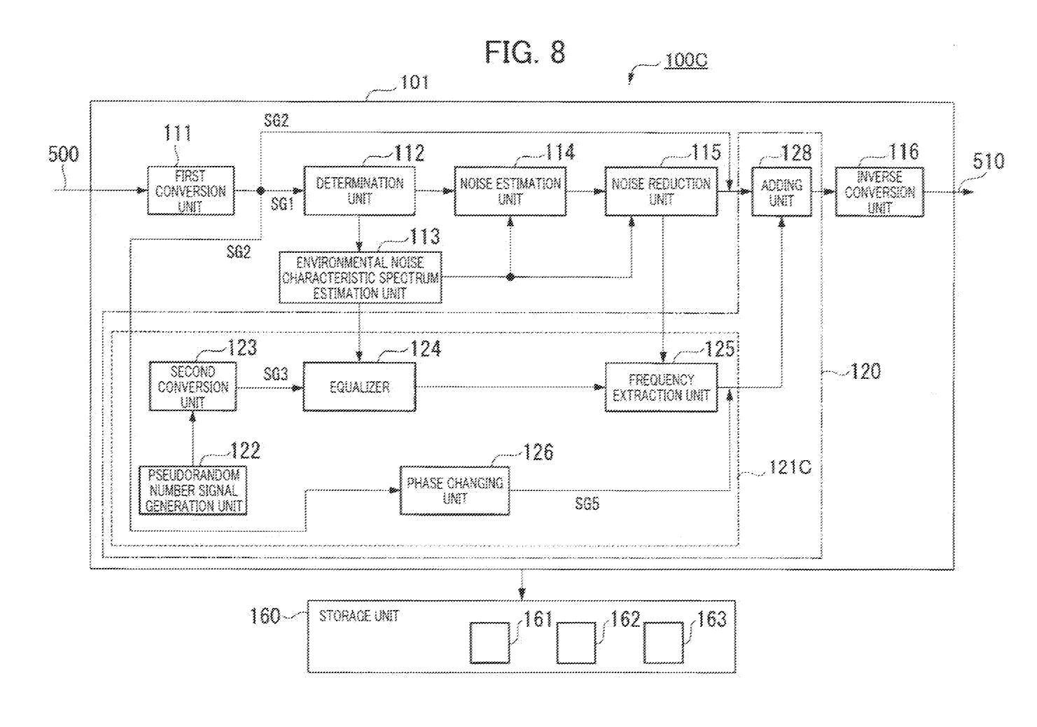

FIG. 8 is an outline block diagram showing an example of the configuration of the signal processing device 100C according to the third embodiment. The configuration of this signal processing device 100C shown in FIG. 8 differs from the configuration shown in FIG. 1 in the configuration of the correction signal generation unit 121. It should be noted that, in FIG. 8, the same reference symbols are appended to configurations corresponding to every part in FIG. 1, and explanations thereof will be omitted.

The correction signal generation unit 121 includes the pseudorandom number signal generation unit 122, the second conversion unit 123, the equalizer 124, the frequency extraction unit 125 and the phase changing unit 126. In other words, this correction signal generation unit 121 of FIG. 8 differs relative to the configuration of the correction signal generation unit 121 of FIG. 1 in the point of including the phase changing unit 126. It should be noted that the phase changing unit 126 may be configured similar to the phase changing unit 120 of FIG. 7.

The phase changing unit 126 changes the inputted phase (phase information) to a different phase from this inputted phase, and outputs the changed phase (phase information). For example, the phase changing unit 126 outputs phase information (reference symbol SG5) of a different phase from the phase expressed by the phase information (reference symbol SG2), based on the phase information (reference symbol SG2) of the frequency spectrum converted by the first conversion unit 111.

In FIG. 8, the phase information of the frequency spectrum of the correction signal added by the adding unit 128 is established as the phase information (reference symbol SG5) outputted by the phase changing unit 126, in place of the phase information (SG4) upon converting the pseudorandom number signal sequence of FIG. 1 into the frequency spectrum RN.

Similarly to the second embodiment, the correction signal generation unit 121 can thereby generate a frequency spectrum at least having a different phase relative to the frequency spectrum of the inputted audio signal, as the frequency spectrum of the correction signal. Consequently, the signal processing device 100C can generate and add a frequency spectrum at least having a different phase relative to the frequency spectrum of the inputted audio signal, as the frequency spectrum (frequency spectrum of correction signal) of the audio signal serving as a replacement for an audio signal like white noise, even in a case of an audio signal like white noise included in the environmental sound other than the predetermined noise also being reduced upon subtracting the predetermined noise from the audio signal.

It should be noted that, although an extremely small probability, there is a possibility of a correction signal of the same phase as the inputted audio signal being generated, in the case of a method generating the frequency spectrum of the correction signal from the pseudorandom number signal explained in the first embodiment. In contrast, according to the configuration of the second embodiment or third embodiment, it is possible to generate the frequency spectrum of the correction signal of a phase that reliably differs from the phase of the frequency spectrum of the inputted audio signal.

It should be noted that the signal processing device 100C of the first embodiment may be configured to include a phase determination unit that determines whether the phase of the frequency spectrum of the inputted audio signal (phase information SG2) and the phase of the frequency spectrum of the generated pseudorandom number signal (phase information SG4) are different phases from, each other. Then, the signal processing device 100C of the third embodiment, for example, may execute processing of adding the frequency spectrum of the correction signal, in the case of the phase of the frequency spectrum of the inputted audio signal (phase information SG2) and the phase of the frequency spectrum of the generated pseudorandom number signal (phase information SG4) being different phases from each other.

### Fourth Embodiment

Next, a fourth embodiment will be explained. The fourth embodiment is an example of the imaging device 1 including the signal processing device 100A, 100B or 100C of the first embodiment, second embodiment or third embodiment.

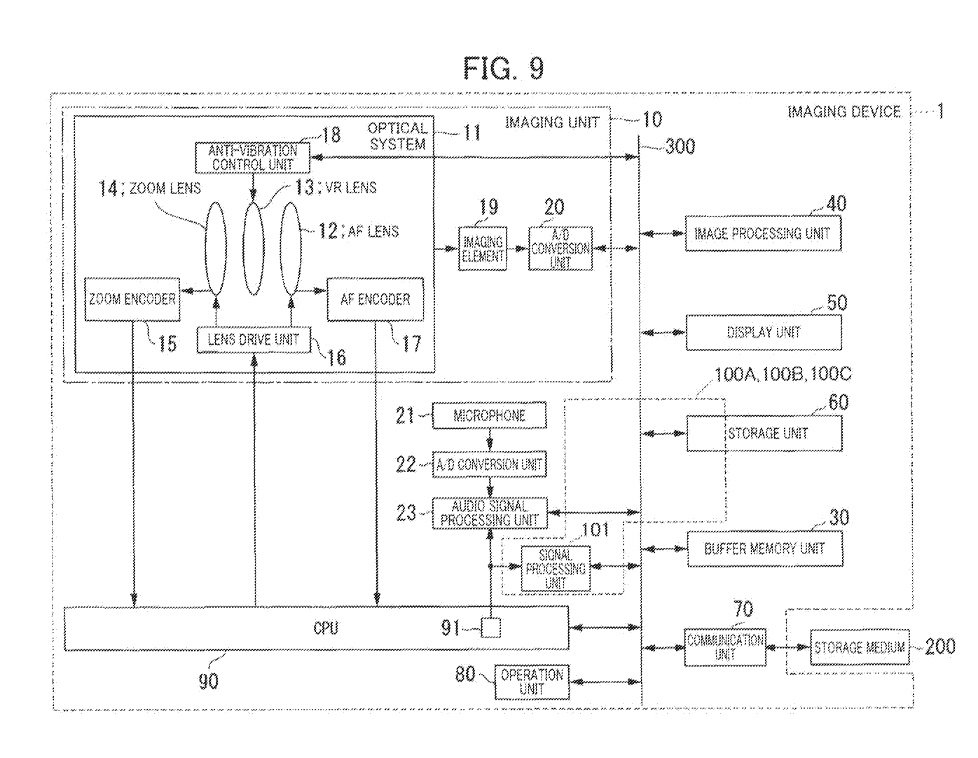

FIG. 9 is an outline block diagram showing an example of the configuration of the imaging device 1 according to the fourth embodiment. The configuration of this imaging device 1 shown in FIG. 9 is a configuration in which the imaging device 400 shown in FIG. 6 further includes the signal processing device 100A, 100B or 100C. It should be noted that, in FIG. 9, the same reference symbols are appended to configurations corresponding to every part in FIG. 1, and explanations thereof will be omitted.

The imaging device 1 includes the imaging unit 10, a CPU 90, an operation unit 80, an image processing unit 40, a display unit 50, a storage unit 60, a buffer memory unit 30, a communication unit 70, a microphone 21, an A/D conversion unit 22, an audio signal processing unit 23, a signal processing unit 101 and a bus 300. Among the configurations included in this imaging device 1, the signal processing unit 101 and a part of the storage unit 60 correspond to the signal processing device 100A, 100B or 100C.

The storage unit 60 stores determination conditions referenced upon scene determination by the CPU 90, photographing conditions, etc., and may include the environmental sound characteristic spectrum storage section 161, the noise storage section 162 and the noise reduction processing information storage section 163 included in the storage unit 160 in FIGS. 1, 7 and 8, for example.

The imaging device 1 configured in this way can execute the noise reduction processing explained using the first embodiment, second embodiment or third embodiment on audio signals stored in the storage medium 100. Herein, the audio signals stored in the storage medium 200 may be an audio signal collected and recorded by the imaging device 1, or may be an audio signal collected and recorded by another imaging device.

Even in a case of the audio signal other than the predetermined noise also being reduced upon subtracting the predetermined noise from the audio signal, the imaging device 1 can thereby generate and add an audio signal serving as a replacement for this sound other than the predetermined noise. For example, upon subtracting predetermined noise from the audio signal, even in a case of the audio signal like white noise included in the environmental sound other than the predetermined noise also being reduced, the imaging device 1 can generate an audio signal serving as a replacement of this audio signal like white noise from the pseudorandom number signal and add thereto.

Consequently, the imaging device 1 can suppress degradation of sound occurring due to an audio signal other than the predetermined noise also being reduced (duo to becoming excessive subtraction of noise). In addition, the imaging device 1 can suppress the residue of noise occurring due to suppressing from becoming insufficient subtraction of noise by worrying over the audio signal other than the predetermined noise also being reduced.

In other words, the imaging device 1 can appropriately reduce the noise included in the audio signal.

It should be noted that the imaging device 1 is not limited to executing noise reduction processing by way of the aforementioned signal processing unit 101 only on audio signals stored in the storage medium 200. For example, the imaging device 1 may execute noise reduction by way of the signal processing unit 101 on an audio signal collected by the microphone 21, and then cause the storage medians 200 to store the audio signal after processing. In other words, the imaging device 1 may execute noise reduction by way of the signal processing unit 101 in real time on an audio signal collected by the microphone 21.

It should be noted that, in the case of the audio signal that has been signal processed by the signal processing unit 101 being stored in the storage medium 200, it may be stored to be temporally associated with, image data captured by the imaging element 19, or may be stored as an image including the audio signal.

As explained using the first to fourth embodiments above, the signal processing device 100A, 100B or 100C, or the imaging device 1 can appropriately reduce the noise included in an audio signal.

### Fifth Embodiment

Hereinafter, a fifth embodiment of the present invention will be explained by referencing too drawings.

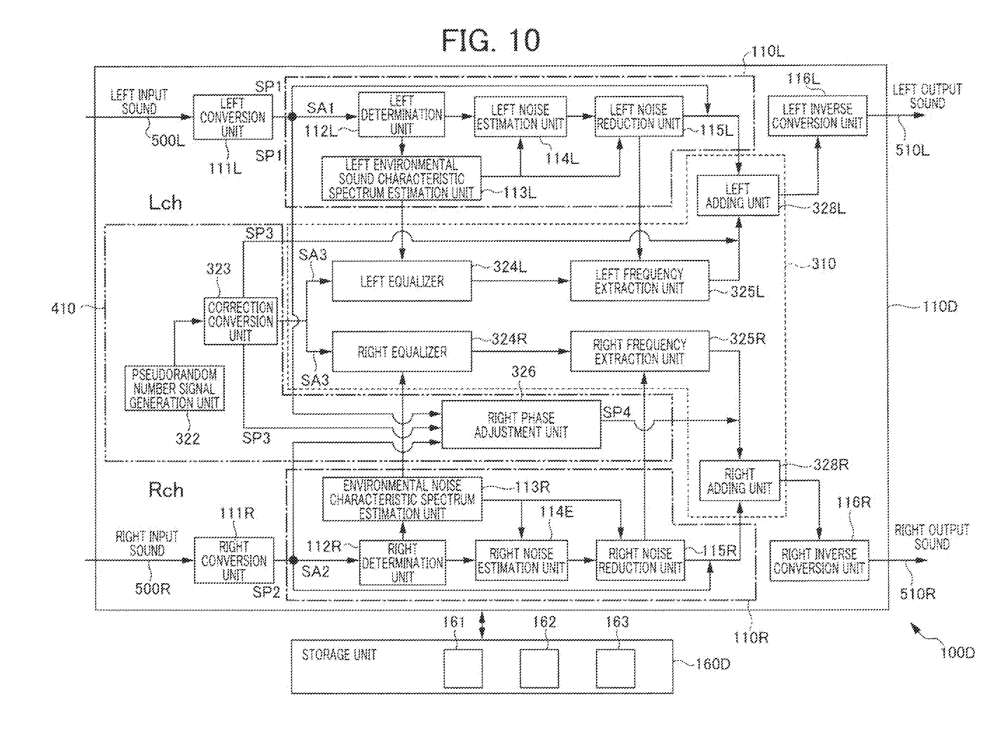

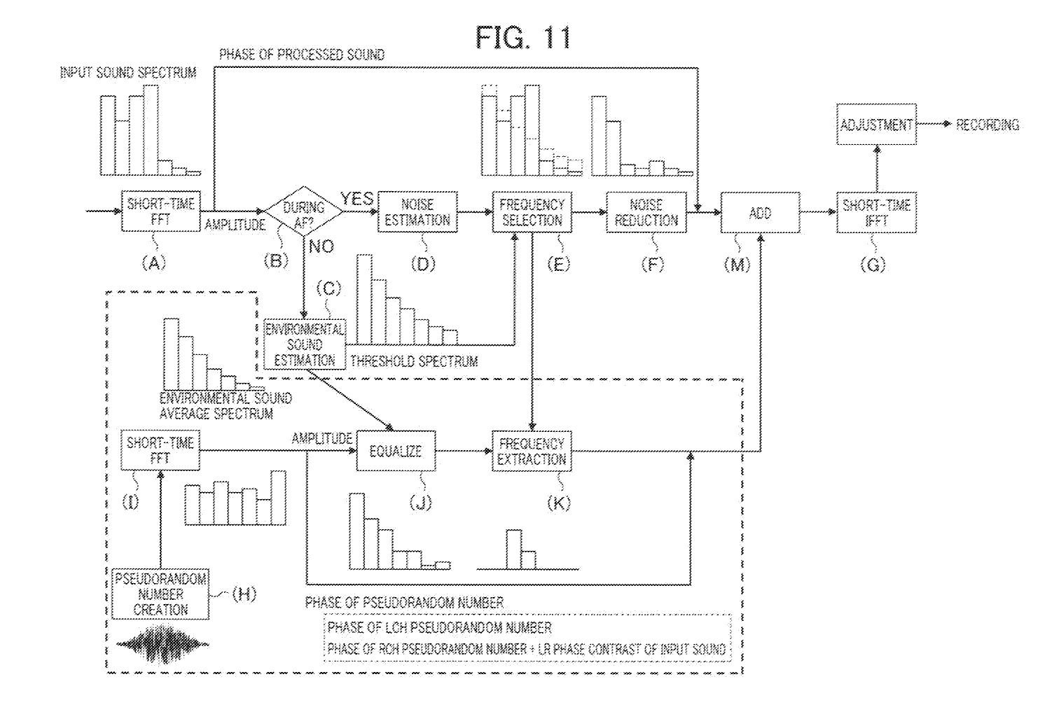

FIG. 10 is an outline block diagram showing an example of the configuration of a signal processing device 100D according to a fifth embodiment of the present invention. FIG. 11 is an illustrative diagram of an example of noise reduction processing including white noise correction by way of the signal processing device 100D. FIG, 12 is a flowchart showing an example of noise reduction processing.

First, an outline of the signal processing device 100D will be explained.

The signal processing device 100D shown in FIG. 10, for example, is a stereo signal processing device that processes audio signals collected by a pair of left and right microphones, executes signal processing on inputted left and right audio signals 500L, 500R, respectively, and outputs the left and right audio signals 510L, 510R after processing.

It should be noted that the present invention is not to be limited thereto, and may be a configuration in which left and right audio signal input units are provided to the signal processing device 100D. The audio signal input unit may be a reading unit for reading an audio signal tree, a storage medium, or may be a portion to which an audio signal is inputted from an external device by way of wired communication, wireless communication, etc.

The signal processing device 100D executes signal processing on the inputted left and right audio signals 500L, 500R, and outputs the audio signals after processing (reference symbols 510L, 510R). The left and right audio signals 500L, 500R, for example, are recorded in the storage medium.

The signal processing device 100D executes signal processing on the audio signals. For example, the signal processing device 100D executes processing to reduce the noise included in the audio signals based on the audio signal of sound recorded, and information indicating the timing at which the operating unit operates in association with this audio signal, like that mentioned above.

Next, the configuration of the signal processing device 100D shown in FIG. 10 will be explained in detail.

The signal processing device 100D includes the signal processing main body 110D and the storage unit 160D.

The configuration of the storage unit 160D of the fifth embodiment is similar to the storage unit 160 of the first embodiment; therefore, the same reference symbols are appended to similar configurations and explanations thereof are omitted.

The signal processing main body 110D executes signal processing such as noise reduction processing, for example, on the inputted audio signals 500L, 500R, and outputs (or causes the storage medium to store) the audio signals 510R, 510R produced by executing this signal processing.

It should be noted that the signal processing main body 110D may be configured to be able to switch between outputting the audio signals 510L, 510R produced by executing noise reduction processing on the inputted audio signals, and the signals of the inputted audio signals 500L, 500R as is.

### <Detailed Configuration of Signal Processing Main Body 110D>

Next, the details of the signal processing main body 110D shown in FIG. 10 will be explained using FIGS. 2 and 3 described earlier and FIGS. 10 and 11.

The signal processing main body 110D includes a left signal processing unit 110L that processes sound inputted from the left side, a right signal processing unit 110R that processes sound inputted from the right side, an environmental sound correction unit 310, a phase information generation unit 410, a left conversion unit 111L, a right conversion unit 111R, a left inverse conversion unit 116L and a right inverse conversion unit 116R.

The left signal processing unit 110L includes a left determination unit 112L, a left environmental sound characteristic spectrum estimation unit 113L, a left noise estimation unit 114L and a left noise reduction unit 115L.

The right signal processing unit 110R includes a right determination unit 112R, a right environmental sound characteristic spectrum estimation unit 113R, a right noise estimation unit 114R and a right noise reduction unit 115R.

The environmental sound correction unit 310 includes a left equalizer 324L and a right equalizer 324R, a left frequency extraction unit 325L and a right frequency extraction unit 325R, and a left adding unit 328L and a right adding unit 328R.

The phase information generation unit 410 includes a pseudorandom number signal generation unit 322, a correction conversion unit 323, and a right phase adjustment unit 326.

Herein, the explanation of the respective signals is the same as the first embodiment for a case of the audio signal shown in FIG. 2(d) (e.g., audio signal collected and recorded by the imaging device) and the signal indicating the timing at which the operating unit operates in association with this audio signal shown in FIG. 2A (e.g., an operating unit included in the imaging device) are read from the storage medium and inputted to the signal processing main body 110D.

It should be noted that, in the following explanation, the left signal processing unit 110L will be explained, and the explanation of the right signal processing unit 110R that is shared with the left signal processing unit 110L will be omitted. In addition, in the drawings, matters appended with “L” at the end of the reference symbol are constituent elements related to processing of the left audio signal (Lch), and matters appended with “R” at the end of the reference symbol are constituent elements related to processing of the right audio signal (Rch).

After the left conversion unit 11L converts the inputted audio signal 500L to a frequency domain signal, the left signal processing unit 110L executes noise reduction process like that explained later on the frequency spectrum of the audio signal, for each frame thereof. Then, the inverse conversion unit 116L inverse Fourier transforms and outputs the frequency spectrum for each frame subjected to noise reduction processing. It should be noted that the audio signal inverse Fourier transformed and outputted may be stored in the storage medium.

Hereinafter, the actions of each constituent element of the left conversion unit 111L, left signal processing unit 110L and left inverse conversion unit 116L will be explained in detail in order referring to FIG. 11.

The inverse conversion unit (frequency domain change conversion unit) 111L converts the inputted audio signal to a frequency domain signal when the audio signal (500L) like that shown in FIG. 2(d) is inputted (FIG. 11(A)).

For example, the left conversion unit 111L divides the inputted audio signal into frames, Fourier transforms the audio signal of each divided frame, and generates a frequency spectrum of the audio signal for each frame. Herein, the left conversion unit 111L obtains the amplitude information (SA1) and phase information (SP1) of the frequency components of the audio signal, upon generating the frequency spectrum of this inputted audio signal.

In addition, the left conversion unit 111L may convert to a frequency spectrum, after multiplying a window function such as a Hanning window by the audio signal of each frame, in the case of converting the audio signal of each frame into a frequency spectrum.

Furthermore, the left conversion unit 111L may Fourier transform by way of fast Fourier transform (FFT: Fast Fourier Transform).

The left determination unit 112L of the left signal processing unit 110L determines whether each frame of the audio signal is a frame of a period in which the operating unit is operating, or a frame of a period in which the operating unit is not operating, based on the timing at which the operating unit operates (FIG. 11(B)).

In other words, the left determination unit 112L determines whether each frame of the audio signal is a frame of a period in which predetermined noise (e.g., noise producing from the operating unit operating) is included, or is a frame of a period in which the predetermined noise is not included, based on the timing at which the operating unit operates.

It should be noted that the left determination unit 112L is not limited to an independent configuration, and may be configured with functions provided by the left environmental noise characteristic spectrum estimation unit 113L or the left noise estimation unit 114L to be described later.

The left environmental sound characteristic spectrum estimation unit 113L is inputted a frequency spectrum of the audio signal converted by the left conversion unit 111L, and estimates the left environmental sound characteristic spectrum from the frequency spectrum of this inputted audio signal (FIG. 11(C)).

Then, the left environmental sound characteristic spectrum estimation unit 113L causes the environmental sound characteristic spectrum storage section 161D to store the estimated left environmental sound characteristic spectrum as the left environmental sound characteristic spectrum.

Herein, the left environmental sound characteristic spectrum refers to the matter of a frequency spectrum of the audio signal of a period in which the predetermined noise (e.g., noise produced by the operating unit operating) is not included, i.e. a frequency spectrum of the audio signal in which environmental sound of the periphery (ambient sound, target sound) in which the predetermined noise is not included is collected.

For example, the left environmental sound characteristic spectrum estimation unit 113L estimates the frequency spectrum of the audio signal (audio signal of environmental sound) of a frame of a period in which the predetermined noise is not included as the environmental sound characteristic spectrum.

In other words, the left environmental sound characteristic spectrum estimation unit 113L estimates the frequency spectrum of the audio signal of a frame of a period in which the operating unit is not operating as the environmental sound characteristic spectrum.

More specifically, for example, the left environmental sound characteristic spectrum, estimation unit 113L estimates, as the environmental sound characteristic spectrum, the frequency spectrum of the audio signal for a frame immediately prior not including a period in which the operating unit operates, as determined by the left determination unit 112L based on the timing at which the operating unit operates.

In the case of the example of the audio signal shown in FIG. 2, the left environmental sound characteristic spectrum estimation unit 113L estimates the frequency spectrum of the audio signal for frame number 43 as the environmental sound characteristic spectrum, for example.

Then, the left environmental sound characteristic spectrum estimation unit 113L causes the environmental sound characteristic spectrum storage section 161D to store the frequency spectrum of the audio signal in this frame number 43 as the environmental sound characteristic spectrum.

The left noise estimation unit 114L estimates the noise for reducing the predetermined noise (e.g., noise generated by the operating unit operating) from the inputted audio signal (FIG. 11(D)). For example, the noise estimation unit 114L estimates the frequency spectrum of noise from the frequency spectrum of the inputted audio signal, based on the timing at which the operating unit operates. Then, the left noise estimation unit 114L causes the noise storage section 162D to store the estimated noise.

For example, the left noise estimation unit 114L estimates the frequency spectrum of noise based on the frequency spectrum of the audio signal in a frame of a period in which the predetermined noise is included and the frequency spectrum of the audio signal in a frame of a period in which the predetermined noise is not included.

In other words, the left noise estimation unit 114L estimates the frequency spectrum of noise based on the frequency spectrum of the audio signal in a frame of a period in which the operating unit is operating, and the frequency spectrum of the audio signal in a frame of a period in which the operating unit is not operating.

More specifically, for example, the left noise estimation unit 114L estimates a difference (FIG. 3(c)) between the frequency spectrum (S46 of FIG. 3(b)) of the audio signal in a frame immediately after the timing at which the operating unit started operation determined based on the timing at which the operating unit operates by the determination unit 112 (and frames in which the operating unit operates extending over the entire period of the frame), and the frequency spectrum (S43 of FIG. 3(a)=environmental sound characteristic spectrum FS) of the audio signal in a frame immediately before the timing at which the operating unit starts operation (and frames in which the operating unit is not operating extending over the entire period of the frame), as the frequency spectrum of noise (NS of FIG. 3(d)).

It should be noted that the left noise reduction unit 115L may select whether to subtract the estimated noise spectrum NS for every frequency bin based on the results of comparing between the frequency spectrum of a frame in which noise is included and the environmental sound characteristic spectrum FS, for every frequency bin.

For example, the left noise reduction unit 116L may establish processing of subtracting the estimated noise spectrum NS from the frequency spectrum of a frame in which noise is included, for a frequency bin in which the strength (amplitude) of the frequency spectrum of the frame in which noise is included is greater than the strength of the environmental sound characteristic spectrum.

On the other hand, the left noise reduction unit 115L may establish processing that does not subtract the estimated noise spectrum NS from the frequency spectrum of a frame in which noise is included, for frequency bins in which the strength of the frequency spectrum of the frame in which noise is included is no higher than the strength of the environmental sound characteristic spectrum FS.

The frequency selection shown in FIG. 11(B) explains this action. It should be noted that this function is included in the noise reduction unit 115L in FIG. 10.

The left inverse conversion unit 116L inverse Fourier transforms (FIG. 11(G)) the frequency spectrum after noise reduction (FIG. 3(e), frequency spectrum SC) produced by the left noise reduction unit 115L subtracting the estimated noise spectrum from the frequency spectrum of the audio signal including noise (FIG. 11(F)). It is thereby possible to obtain an audio signal with reduced noise.

Upon inverse Fourier transformation in this left inverse conversion unit 116L, the phase information (SP1) of the input audio signal obtained in the left conversion unit 111L is used.

It should be noted that the left inverse conversion unit 116L may inverse Fourier transform according to inverse fast Fourier transformation (IFFT: Inverse Fast Fourier Transform).

As described above, the left signal processing unit 110L reduces noise in the audio signal by way of spectral subtraction processing on the audio signal, based on the frequency spectrum of noise (estimated noise spectrum NS).

In other words, spectral subtraction processing is a method that reduces the noise of the audio signal by first converting the audio signal to frequency domain by Fourier transformation, then after subtracting the noise in the frequency domain, performing inverse Fourier transformation.

It should be noted that the function of each constituent element of the right signal processing unit 110R and the contents of spectral subtraction processing are entirely the same as the above mentioned left signal processing unit 110L.

Referring back to the explanation of FIG. 10, the respective configurations included in the signal processing main body 110D will continue to be explained. In the following explanation, the environmental sound characteristic spectrum FS explained using FIGS. 2 and 3 is a spectrum estimated by the environmental sound characteristic spectrum estimation unit 113 and stored in the environmental sound characteristic spectrum storage section 161D.

It should be noted that an environmental sound characteristic spectrum established in advance may be stored in the environmental sound characteristic spectrum storage section 161D. In addition, the estimated noise spectrum NS explained using FIGS. 2 and 3 is estimated by the left noise estimation unit 114 and stored in the noise storage section 162D. It should be noted that estimated noise established in advance may be stored in the noise storage section 162D.

As mentioned above, the signal processing device 100D, for example, performs noise reduction processing on audio signals, by subtracting the estimated noise spectrum NS estimated based on the timing at which the operating unit operates, from the frequency spectrum of the audio signal in which noise is included.

However, in such noise reduction processing, in cases like the frequency spectrum of an audio signal other than at least the predetermined noise (e.g., noise produced from the operating unit operating) being included in the estimated noise spectrum NS, the audio signal of environmental noise other than the predetermined noise may also be reduced, and thus degradation of the environmental sound may occur.

In addition, in cases like reducing unsteady noise (e.g., noise for which the magnitude varies, noise generating intermittently, etc.), a difference may arise between the noise actually contaminating the audio signal and the estimated noise, and thus degradation of the sound may occur from excessive reduction of the noise.

In such a case, audio signals having little strength of the frequency spectrum tend to degrade more, for example, degradation of an audio signal having a wide frequency band and little strength of the frequency spectrum tends to occur, as in the white noise included in the environmental sound (sound important in expressing the ambience of a scene thereof).

Herein, when decreasing the subtracted amount of the estimated noise spectrum NS so that the degradation, of environmental sound does not occur, the residue of noise may occur from insufficient subtraction of noise. On the other hand, if the subtraction amount is increased trying to avoid such insufficient subtraction of noise, sounds like white noise included in the environmental sound may be further subtracted (reduced), and may become sound with discomfort like sound such as white noise being interrupted only in a frame period on which noise reduction processing was performed.

The environmental sound correction unit 310 of the signal processing device 100D corrects environmental sound for which there is a concern over degradation occurring in this noise reduction processing.

Next, an example of the configurations of this environmental sound correction unit 310 and phase information generation unit 410 will be explained in detail.

As mentioned earlier, the environmental sound correction unit 310 includes the left equalizer 324L and right equalizer 324R, the left frequency extraction unit 325L and right frequency extraction unit 325R, and the left adding unit 328L and the right adding unit 328R.

It should be noted that the left equalizer 324L, the right equalizer 324R, the left frequency extraction unit 325L and the right frequency extraction unit 325R have the name configurations and functions, respectively, and are provided to correspond to the left signal processing unit 110L and the right signal processing unit 110R in the aforementioned signal processing main body 110D. Hereinafter, the left equalizer 324L and the left frequency extraction unit 325L will be explained, and explanations for the right equalizer 324R and the right frequency extraction unit 325R will be omitted, except for oases particularly required.

The phase information generation unit 410 generates ere frequency spectrum of the correction signal based on the pseudorandom number signal and environmental sound characteristic spectrum FS.

The pseudorandom number signal generation unit 322 generates a pseudorandom number signal sequence by way of the linear congruent method, a method using a linear feedback shift register, a method using chaos random numbers, or the like (FIG. 11(H)).

It should be noted that the pseudorandom number signal generation unit 122 may generate a pseudorandom number signal sequence using a method other than the aforementioned methods.

The correction conversion unit 323 converts the pseudorandom number signal sequence generated by the pseudorandom number signal generation unit 322 into a frequency domain signal (FIG. 11(I)). For example, the correction conversion unit 323 divides the pseudorandom number signal sequence into frames, Fourier transforms the pseudorandom number signal of each divided frame, and generates a frequency spectrum of she pseudorandom number signal in each frame.

In addition, the correction conversion unit 323 may convert to a frequency spectrum after multiplying a window function such as a Hanning window by the pseudorandom number signal of each frame, in the case of converting the pseudorandom number signal of each frame into frequency spectra. In addition, the correction conversion unit 323 may Fourier transform by way of fast Fourier transform (FFT: Fast Fourier Transform). It should be noted that the correction conversion unit 323 may be configured as a shared configuration with the left conversion unit 111L and the right conversion unit 111R.

It should be noted that the correction conversion unit 323 obtains the amplitude information (SA3) and phase information (SP3) of the frequency components of the pseudorandom number signal, upon generating the frequency spectrum of the pseudorandom number signal.

The correction conversion unit 323 inputs signals after conversion to the left and right equalizers (left equalizer 324L, right equalizer 324R).

The left equalizer 324L generates the frequency spectrum of the correction signal based on the frequency spectrum of the pseudorandom number signal inputted from the correction conversion unit 323, and the environmental sound characteristic spectrum FS inputted from the left environmental sound characteristic spectrum estimation unit 113L.

For example, the left equalizer 324L generates the frequency spectrum of the correction signal (FIG. 11(J)), by equalizing the frequency spectrum of the pseudorandom number signal using the environmental sound characteristic spectrum FS.

Similarly, the right equalizer 324R generates the frequency spectrum of the correction signal, by equalizing the frequency spectrum of the pseudorandom number signal using the environmental sound characteristic spectrum FS inputted from the right environmental sound characteristic spectrum estimation unit 113R.

Therefore, since the signals correcting the signals inputted to the left and right are decided based on the sound inputted from the left and right, the relationship between the left correction signal and the right correction signal (second relationship) is generated (corrected) so as to be included in a predetermined range including the relationship (first relationship) between the left input sound (left environmental sound characteristic spectrum) and the right input sound (right environmental sound characteristic spectrum)

More specifically, the left equalizer 324L, for example, generates a correction signal, by multiplying the frequency spectrum of the pseudorandom number signal and environmental sound characteristic spectrum FS for every frequency bin, and standardizing (normalising, averaging) so that the sum or the frequency spectra of all frequency bins (sum of amplitudes of all frequency components, or sum of strengths of all frequency components) becomes substantially equal to the sum of the environmental sound, characteristic spectra FS (sum of spectra of all frequency bins).

For example, the left equalizer 324L may calculate the correction signal according to the mathematical formula 1 explained in the first embodiment.

It should be noted that the environmental sound spectrum FS(k) expressed in mathematical formula 1 may employ an average environmental sound spectrum AE(k) made by adding up the environmental sound spectra acquired from a plurality of predetermined frames, and taking the average.

The left frequency extraction unit 325L and right frequency extraction unit 325R select the frequency bins to add by the left adding unit 328L and the right adding unit 328R, respectively, and extract the frequency spectra of the selected frequency bins, among the frequency spectra of the correction signal generated by the left equalizer 324L and the right equalizer 324R. Hereinafter, an explanation will be given with the left frequency extraction unit 325L as an example.

For example, the left frequency extraction unit 325L selects the frequency bin to add by the left adding unit 328L, based on the information for every frequency bin indicating whether the left noise reduction unit 115L has subtracted the estimated noise spectrum NS (FIG. 11(K)).

In other words, the left frequency extraction unit 325L extracts the frequency spectrum of the correction signal for the frequency bin to add by the left adding unit 328L, based on information for every frequency bin indicating whether the left noise reduction unit 115L has subtracted the estimated noise spectrum NS.

It should be noted that the left frequency extraction unit 325L may acquire information for every frequency bin indicating whether the estimated noise spectrum NS has been subtracted, by referencing the noise reduction processing information storage section 163.

The left adding unit 328L and the right adding unit 328R add the frequency spectra of the correction signals generated by the left equalizer 324L and the right equalizer 324R to the frequency spectra of the audio signals produced after the left noise reduction unit 115R and the right noise reduction unit 115R subtracted the estimated noise spectrum NS therefrom, respectively (FIG. 11(M)). Hereinafter, an explanation will be given with the left adding unit 328L as an example.

For example, the left adding unit 328L adds the frequency spectrum of the correction signal for the frequency bin established as the addition target by the left frequency extraction unit 323L.

In other words, the left adding unit 328L adds the frequency spectrum of the correction signal to the frequency spectrum of the audio signal produced after having subtracted the estimated noise spectrum be NS, for frequency bins not having been subtracted upon the left noise reduction unit 115L subtracting the estimated noise spectrum NS from the frequency spectrum of the audio signal for every frequency bin.

On the other hand, the left adding unit 328L reduces the addition amount of the frequency spectrum of the correction signal adding to the frequency spectrum of the audio signal produced after having subtracted the estimated noise spectrum NS therefrom, for a frequency bin not subtracted, upon the left noise reduction unit 115L subtracting the estimated noise spectrum NS from the frequency spectrum of the audio signal for every frequency bin (e.g., sets addition amount to “0”, i.e. does not add).

It should be noted that the left adding unit 328L may reduce the addition amount of the frequency spectrum of the correction signal adding to the frequency spectrum of the audio signal produced after having subtracted the estimated noise spectrum NS therefrom, for the frequency bin for which the subtraction amount was reduced upon the left noise reduction unit 115L subtracting the estimated noise spectrum NS from the frequency spectrum of the audio signal for every frequency bin.

For example, the left adding unit 328L may cause the addition amount of the frequency spectrum of the correction signal to differ for every frequency bin, depending on the subtracted amount of every frequency bin by the left noise reduction unit 115L.

In other words, in the case of the subtracted amount for every frequency bin by the left noise reduction unit 115L being large, the left adding unit 328L may increase the addition amount of the frequency spectrum of the correction signal for the frequency bins thereof, and in the case or the subtracted amount for every frequency bin by the left noise reduction unit 115L being small, may decrease the addition amount or the frequency spectrum of the correction signal for the frequency bins thereof.

Then, as mentioned above, the left signal processing unit 110L generates an audio signal of time domain after noise reduction processing (FIG. 11(G)), by inverse Fourier transforming in the left inverse conversion unit 116L the frequency spectrum produced by the left adding unit 328L adding the frequency spectrum SD to the frequency spectrum SC. Upon this inverse Fourier transformation in the left inverse conversion unit 116L, the phase information (SP3) of the frequency component of the pseudorandom number signal obtained by the correction conversion unit 323 is used in the frequency spectrum SD outputted as the addition target from the left frequency extraction unit 325L.

Herein, in the present embodiment, the phase of the frequency spectrum SE (refer to SP3 of FIG. 10) of the pseudorandom number signal for each frame, produced by the correction conversion unit 323 converting the pseudorandom number signal sequence generated by the pseudorandom number signal generation unit 322 into a frequency domain signal, differs from the phase of the frequency spectrum SC (refer to SP1, SP2 of FIG. 10) of the input audio signal. The frequency spectrum of the correction signal fox correcting the audio signal of sound such as white noise is thereby obtained.

However, since the outputs generated by the pseudorandom number signal generation unit 322 and the correction conversion unit 323 are used in the two input sounds (Lch, Rch) generating stereo sound, the phases of the frequency spectra of the correction signals for both inputs (Lch, Rch) are the same as they are.

As a result thereof, if the correction signals are oriented in the vicinity of the center of the left and right inputs, and generate audio signals of time domain after noise reduction processing by overlapping such correction signals, there is a possibility of a strange noise not present originally occurring in the vicinity of the center.

It should be noted that, even in a case of using random information prepared independently from both inputs, respectively, the position of a part overlapping the environmental sound correction signal will change with the input sound, and there is a possibility of the perceived sound becoming unnatural.

For this reason, the present configuration includes the right phase adjustment unit 326 that adjusts the phase information of the correction signal to the right audio signal.

Based on the phase information (SP3) of the frequency component of the pseudorandom number signal outputted from the correction conversion unit 323, the right phase adjustment unit 326 generates the right correction phase information (SP4) so that, the ratio relative to this becomes equal to the phase difference between the left and right input sounds.

In other words, the right correction phase information (SP4) outputted by the right phase adjustment unit 326 is set so as to become a phase difference relative to the phase of the left correction signal, equal to the phase difference of input sounds.

The orientations of the left and right correction signals thereby become equal to the orientations of the left and right inputs, and can correct so as to be audible naturally, without the orientation of the audio signal in time domain after noise reduction processing generated by overlapping such correction signals changing with input sound.

As explained above, the signal processing device 100D generates correction signals that correct the signals of white noise (sound important in expressing the ambience of a scene thereof) included in the environmental sound for which degradation may occur in noise reduction processing of the phase information generation unit 410 and the environmental sound correction unit 310, and performs processing to add the generated correction signals to the audio signals after noise reduction processing.

More specifically, the phase information generation unit 410 end the environmental sound correction unit 310 create white noise, equalise the white noise using sound of a segment in which noise is not generated (in frequency domain) to create a pseudo environmental sound signal (frequency domain), as well as extracting only a frequency component on which noise reduction was performed among the pseudo environmental sound to create an environmental sound correction signal (frequency domain). Then, the audio signal after noise reduction is obtained by adding the frequency domain signal on which noise reduction was performed and the environmental sound correction signal, and then converting to a time domain signal. In addition, the phase information of white noise is used as the phase information of the environmental sound correction signal.

By doing as such, it is possible to interpolate the environmental sound that was suppressed by the noise reduction processing. In addition, by adding only the environmental sound correction signal corresponding to the frequency component on which noise reduction was performed, it is possible to curb the sense of discomfort from adding artificially created sound. Since the phase information of sound (input sound) contaminated by noise is not used in the phase information of the environmental senna correction signal, the reduced noise will not return by the addition of the environmental sound correction signal.

In addition, the environmental sound correction unit 310 uses the right correction phase information (SP4) generated by the right phase adjustment unit 328 as the phase information of the right correction signal, whereby the phase difference of the right correction signal relative to the phase of the left correction signal becomes a phase difference equal to the phase difference of input sounds.

The orientations of the left and right correction signals thereby become equal to the orientations of the left and right inputs, and thus it is possible to correct so as to be audible naturally, without the orientation of the audio signals of time domain after noise reduction processing generated by overlapping such correction signals changing with input sound.

### (Operations of Noise Reduction Processing)

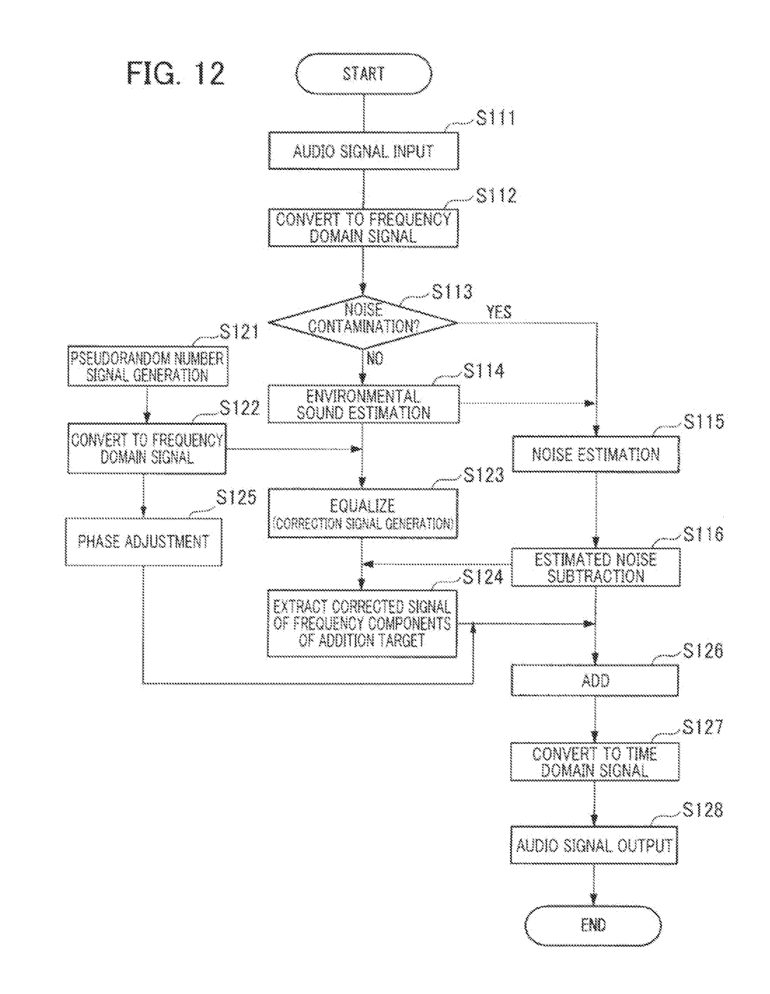

Next, the operations of noise reduction processing in the present, embodiment will be explained by referencing FIG. 12. FIG. 12 is a flowchart showing an example of noise reduction processing of the present embodiment. It should, be noted that the steps in FIG. 12 and in the following explanation are noted with “S”.

First, the signal processing main body 110D reads audio signals from the storage medium. The read audio signals are inputted to the left conversion unit 111L and right conversion unit 111R of the signal processing main body 110D (S111).

Next, the left conversion unit 111L and the right conversion unit 111R convert the inputted audio signals into frequency domain signals. For example, the left conversion unit 111L and the right conversion unit 111R divide the inputted audio signals into frames, Fourier transform the audio signals of each divided frame, and generate frequency spectra of audio signals of each frame (S112, FIG. 11(A)).

Next, the left determination unit 112L and the right determination unit 112R determine whether each frame of the audio signals is a frame of a period in which the operating unit is operating, or a frame of a period in which the operating unit is not operating, based on the timing at which the operating unit operates (S113, FIG. 11(B)).

In other words, the left determination unit 112L and the right determination unit 112R determine whether each frame of the audio signals is a frame of a period in which predetermined noise (e.g., noise produced by the operating unit operating) is included (whether the predetermined noise is contaminating), based on the timing at which the operating unit operates.

The left environmental sound characteristic spectrum estimation unit 113L and the right environmental sound characteristic spectrum estimation unit 113R estimate the environmental sound characteristic spectrum FS (frequency spectrum of environmental sound, refer to FIG. 4(b)) based on the frequency spectrum of the audio signal of a frame for which it was determined to be a frame of a period in which the predetermined noise is not included (S113>NO), from among the respective frames of the inputted audio signal (S114, FIG. 11(C)).

On the other hand, the left noise estimation unit 114L and right noise estimation unit 114R estimate the frequency spectrum of noise (estimated noise spectrum NS) based on the frequency spectrum SB (refer to FIG. 4(a)) of the audio signal of a frame for which it was determined to be a frame of a period in which the predetermined noise is included (S113>YES), from among the respective frames of the inputted audio signed, and the environmental sound characteristic spectrum FS.

For example, the left noise estimation unit 114L and the right noise estimation unit 114R generate the estimated noise spectrum NS by subtracting the environmental sound characteristic spectrum FS from the frequency spectrum SB of the audio signal for the frame of a period, in which the predetermined noise is included; for every frequency bin (S115, FIG. 11(D)).

Next, for every frequency bin (every frequency component), the left noise reduction unit 115L and the right noise reduction unit 115R subtract the estimated noise spectrum NS estimated by the left noise estimation unit 114L from the frequency spectrum SB (S116, FIG. 11(F)). For example, the left noise reduction unit 115L and the right noise reduction unit 115R compare between the frequency spectrum SB and the environmental sound characteristic spectrum FS for every frequency bin, and subtract the estimated noise spectrum NS only for the frequency bins in which the strength of the frequency spectrum SB is no higher than the strength of the environmental sound characteristic spectrum FS (refer to FIG. 4(d)).

On the other hand, the pseudorandom number signal generation unit 322 generates a pseudorandom number signal sequence (S121, FIG. 11(H)).

Next, the correction conversion unit 323 converts the pseudorandom number signal sequence generated by the pseudorandom number signal generation unit 322 into a frequency domain signal (S122, FIG. 11(1)). For example, the pseudorandom number signal generation unit 322 divides the pseudorandom number signal sequence into frames, Fourier transforms the pseudorandom number signal of each divided frame, and generates a frequency spectrum RN (refer to FIG. 4(c)) of the pseudorandom number signal for each frame.

Next, the left equalizer 324L and the right equalizer 324F generate the frequency spectrum SE of the correction signal (refer to FIG. 4(e)) by equalizing the frequency spectrum RN of the pseudorandom number signal using the environmental sound characteristic spectrum FS (S123, FIG. 11(J)).

In addition, the left frequency extraction unit 325L and the right frequency extraction unit 325R extract the frequency spectrum SD of a frequency bin serving as the addition target by the left adding unit 328L and the right adding unit 328R, from among the frequency spectra SE of the correction signal (S124, FIG. 11(K)). In other words, the frequency extraction unit 125 extracts the frequency spectrum SD of the correction signal for the frequency bins that are the addition targets, from the frequency spectrum SE of the correction signal. For example, the left frequency extraction unit 325L and right frequency extraction unit 325R select frequency bins in which the left noise reduction unit 115 subtracted the estimated noise spectrum NS in Step S116 as the frequency bins of addition targets, and extract the frequency spectrum SD of the selected frequency bins.

On the other hand, the right phase adjustment unit 326 generates, from the phase information (SP3) of the frequency component of the pseudorandom number signal obtained by the correction conversion unit 323, right correction phase information (SP4) for which the ratio relative thereto becomes equal to the phase difference between the left and right input sounds (S125). The right correction phase information (SP4) generated herein is used in the generation of an audio signal of time domain after noise reduction processing by inverse Fourier transformation in Step S27 to be described later.

Then, the left adding unit 328L and the right adding unit 328R add the frequency spectrum SD of the correction signal extracted in Step S124 to the frequency spectrum SC (refer to FIG. 4(d)) produced by the estimated noise spectrum NS being subtracted from the frequency spectrum SB in Step S116 (S126, FIG. 11(M)).

Next, the left inverse conversion unit 116L and the right inverse conversion unit 116R generate audio signals of a time domain after noise reduction processing, by inverse Fourier transforming the frequency spectrum arrived at by adding the frequency spectrum SD to the frequency spectrum SC (S127, FIG. 11(G)).

Then, the signal processing main body 110D outputs an audio signal of time domain after noise reduction processing (S123).

It should be noted that Step S26 and step S27 may exchange places before and after in this processing sequence. In other words, the output audio signal may be made by performing inverse Fourier transformation of the frequency spectrum SC from which the estimated noise spectrum NS for the left and right audio signals was subtracted, and inverse Fourier transformation of the frequency spectrum SD of the correction signal, respectively converting to audio signals, and then adding both.

### <Configuration Example of Imaging Device Having Sound Collecting Function>

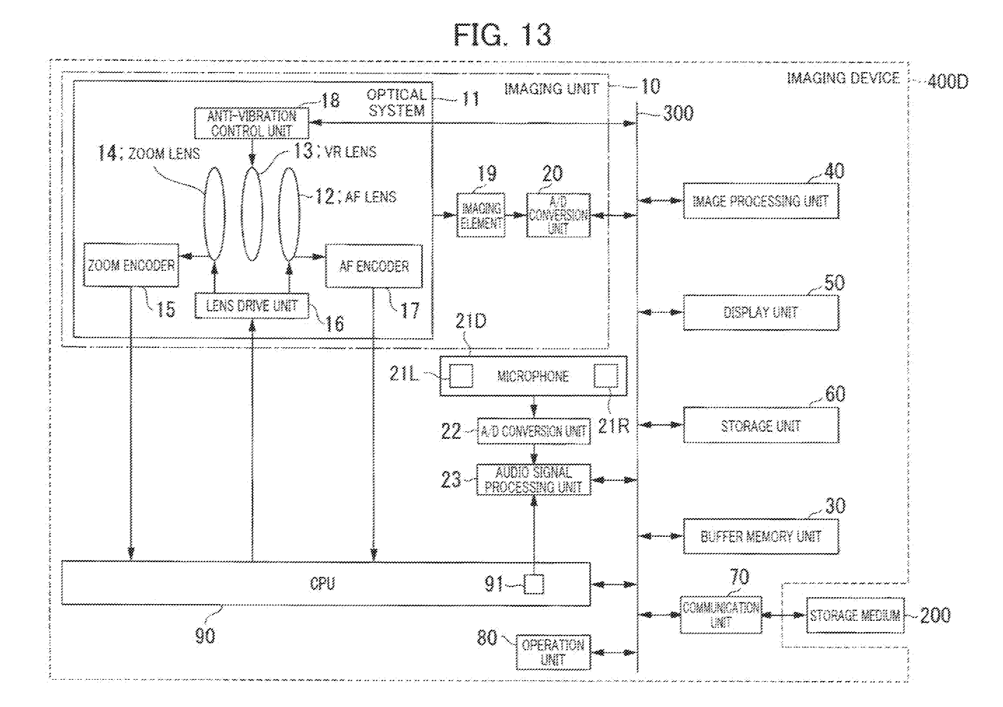

Next, the configuration of an imaging device 400D collecting an audio signal stored in the aforementioned storage medium will be explained based on FIG. 13. If should be noted that the difference between the imaging device 400D of the present embodiment and the aforermentioned imaging device 400 explained with FIG. 9 is in the point of the microphone 21D in the imaging device 400D of the present embodiment including a left microphone 21L and a right microphone 21R. Since the other components are similar, explanations of similar components will be omitted.

The microphone 21D includes the left microphone 21L and the right microphone 21R, and converts to analog audio signals according to the collected sound. The A/D conversion unit 22 converts the analog audio signal converted by the microphone 21D into a digital audio signal.

The audio signal processing unit 23 executes signal processing on the digital audio signal converted by the A/D conversion unit 22 to cause to be stored in the storage medium 200. The audio signal processing unit 23 causes the storage medium 200 to store timing information of the operating unit in association with the audio signal. The audio signals to be stored by the audio signal processing unit 23 are an audio signal stored in association, with video, an audio signal recorded in order to add voices to still images stored in the storage medium 200, an audio signal recorded as a voice recording, or the like.

Hereinafter, a modified example of the aforementioned embodiment will be explained.

### (Regarding Frames in FIG. 2)

FIG. 2 was explained with an example having overlap between each frame. However, it is not limited thereto, and there may be no overlap between each frame. For example, frames adjacent to each other may establish periods so as be independent for every frame.

In addition, in the explanation using the aforementioned FIGS. 2, 3 and 4, a case of the audio signal being divided into frames irrespective of (a) the signal indicating the timing at which the operating unit operates was explained (refer to FIG. 2(c)).

However, it is not limited thereto, and the signal processing main body 110D may control the positions of dividing the frames according to (a) the signal indicating the timing at which the operating unit operates. For example, the signal processing main body 110D may generate frames relative to the audio signal so that the timing of (a) the signal indicating the timing at which the operating unit operates changes from low level to high level (refer to reference symbol 0 in FIG. 2) and the boundary of the frames of the audio signal match.

Then, the signal processing main body 110D may execute the aforementioned noise reduction processing based on the period prior to the operating unit operating and a period of the operating unit operating, according to the signal indicating the timing at which the operating unit operates.

### (Regarding Phase Adjustment on Correction Signal)

With the configuration shown in FIG. 10, the right phase adjustment unit 326 adjusts the phase information of the correction signal to the right audio signal. However, without limitation, the right phase adjustment unit 326 may be configured to adjust the phase information of the correction signal to the left audio signal.

In addition, in the fifth embodiment, a method of generating the frequency spectrum of the correction signal by equalizing the frequency spectrum of the generated pseudorandom number signal using the environmental sound characteristic spectrum was explained. However, the present invention is not limited thereto, and similarly to the second embodiment, the frequency spectrum for correction may be generated by changing the phase of the environmental sound characteristic spectrum FS to a different phase, without using the pseudorandom number signal sequence.

### (Position of Signal Processing Device)

In the aforementioned embodiment, the signal processing device 100D independent from the imaging device was explained; however, the present invention is not limited thereto, and the signal processing device may be provided to the imaging device.

As explained above, according to the present embodiment, the signal processing device 100D can appropriately reduce the noise included in audio signals.

It should be noted that, in the above explanation, although sound produced mainly by the optical system 11 operating was explained as the noise (predetermined noise) included in the audio signal, the noise is not limited thereto.

For example, the case of sound produced when a button or the like included in the operation unit 80 was depressed is also similar. In this case as well, the signal detecting that a button or the like included in the operation unit 80 was depressed is inputted to the timing detection unit 91 of the CPU 90.

Consequently, the timing detection unit 91 can detect the operating timing of the operation unit 80 or the like, similarly to the case of the optical system 11 driving. In other words, it tray establish information indicating the operating timing of the operation unit 80 or the like as the information indicating the timing at which the operating unit operates.

In addition, the operating unit may be another configuration in which sound generates by operating (alternatively, has a possibility of sound generating), without limitation to the respective lenses included in the optical system 11 or the operation unit 80. For example, the operating unit may be a pop up type light source (e.g., light source for photography, flash unit (flash), etc.) for which sound generates upon popping up.

In addition, in the above explanation, examples were explained in which the signal processing device 100D or the imaging device 1 executes processing by way of the signal processing unit 110 on audio signals of sound collected by an imaging device (e.g., the imaging device 400 or the imaging device 1); however, the processing by way of the signal processing unit 110 may be executed on audio signals of sound collected in a device other than an imaging device.

In addition, in the above fourth embodiment and modified example, configurations were explained in which the signal processing device 100A, 100B, 100C or 100D (signal processing unit 110, 100D) is equipped to the imaging device 1; however, the signal processing device 100A, 100B, 100C or 100D (signal processing unit 110, 100D) may he equipped to another device such as an audio recording device, mobile telephone, personal computer, tablet type terminal, electronic toy, or communication terminal, for example.

It should be noted that the signal processing unit 110 (signal processing main body 110D) in FIGS. 1, 7, 8 and 10, or each part included in the signal processing unit 110 (signal processing main body 110D) may be realized by dedicated hardware, and may be realized by memory and a microprocessor.

It should be noted that the signal processing unit 110 (signal processing main body 110D) in FIGS. 1, 7, 8 and 10, or each part equipped to the signal processing unit 110 (signal processing main body 110D) may be realized by dedicated hardware; this signal processing unit 110 (signal processing main body 110D) or each part equipped to this signal processing part 110 (signal processing main body 110D) may be configured by memory and a CPU (central processing unit), or a program for realizing the functions of the signal processing unit 110 (signal processing main body 110D) or each part equipped to this signal processing unit 110 (signal processing main body 110D) may be loaded into memory and executed, thereby allowing the functions thereof to be realized.

In addition, the processing by the signal processing unit 110 or each part equipped to this signal processing unit 110 (signal processing main body 110D) may be performed by recording a program for real icing the functions of the signal, processing unit 110 of FIGS. 1, 7, 8 and 10 (signal processing main body 110D) or each part equipped to this signal processing unit 110 (signal processing main body 110D) in a computer readable recording medium, then reading the program recorded on this recording medium into a computer system and executing. It should be noted that the “computer system” referred to herein is defined as including OS and hardware such as peripheral devices.

In addition, the “computer system” is defined as also including a homepage providing environment (or display environment) in the case of using a WWW system.

In addition, “computer readable recording medium” refers to portable media such as a flexible dish, magneto optical disk, ROM and CD ROM, and a storage device such as a hard disk built into the computer system.

Furthermore, the “computer readable recording medium” is defined as including matters retaining a program over a short time or dynamically as in a communication line in the case of communicating a program via a communication link such as a network like the Internet and telephone lines, and matters retaining a program, for a limited time, as in volatile memory inside of a computer system serving as a server or client in this case.

In addition, the above mentioned program may be for realizing a part of the aforementioned functions, or may further be able to realise the aforementioned functions in combination with a program already recorded in the computer system.

The above mentioned embodiment applies the present invention to stereo input in which the input sound is 2 channels. However, the present invention is not limited to stereo input, and can be applied also to a configuration including a plurality of collected sound inputs (e.g., 5.1 channel sound, etc.).

In addition, after processing by the adding unit in the above mentioned embodiment, short time IFFT processing was performed; however, it is not limited thereto, and the addition processing may be done after having performed short, time IFFT on the left and right.

Although embodiments of the present invention have been described in detailed above by referencing the drawings, the specific configurations are not to be limited to these embodiments, and designs, etc. of a scope not departing from the spirit of the present invention are also included thereby.

It should be noted that the embodiments and modified embodiments can be employed in combinations as appropriate; however, detailed explanations thereof are omitted herein. In addition, the present invention is not to be limited, by the embodiments explained in the foregoing.

### EXPLANATION OF REFERENCE NUMERALS

1, 400, 400D: imaging device

100A, 100B, 100C, 100D: signal processing device

110: signal processing unit

110D: signal processing main body

110L: left signal processing unit

110R; right signal processing unit

111: first conversion unit (conversion unit)

111L: left conversion unit

111R: right conversion unit

112L: left determination unit

112R: right determination unit

115: noise reduction unit (subtraction unit)

121: correction signal generation unit (generation unit)

123: second conversion unit (conversion unit)

128: adding unit

310: environmental sound correction unit

326: right phase adjustment unit

328L: left adding unit

328R] right adding unit

410: phase information generation unit

500L: left input sound

500R: right input sound

1-25. (canceled)

26. A sound processing device for reducing noise that is a object to be removed from first sound data, the device comprising:
an adding unit that adds fourth sound data to second sound data, in which the second sound data is data produced by reducing the noise from the first sound data and the fourth sound data is data based on third sound data that does not include the noise.

27. The sound processing device according to claim 26, wherein:
noise information indicating that the noise generated and sound data are associated, and
comprising:
a determination unit that determines data including the noise from the sound data, based on the noise information.

28. The sound processing device according to claim 27, wherein:
the sound data at least includes first sound data to which the noise information is associated and the third sound data to which the noise information is not associated, and
the determination unit extracts the first sound data from the sound data based on the noise information.

29. The sound processing device according to claim 28, wherein:
the determination unit extracts the third sound data from the sound data based on the noise information, the third sound data being data to which the noise information is not associated.

30. The sound processing device according to claim 27, wherein:
the noise information is information indicating that an operating unit that generates the noise operated during collection of the sound data.

31. The sound processing device according to claim 30, wherein:
the operating unit is arranged in an imaging device that performs imaging, and
the operating unit is a lens arranged in the imaging device, or an operation unit arranged in the imaging device.

32. The sound processing device according to claim 30, wherein:
the information indicating that the operating and operated is information based on a control signal generating in order to operate the operating unit.

33. The sound processing device according to claim 26, wherein:
the fourth sound data is data corrected based on generated data and the third sound data.

34. The sound processing device according to claim 33, further comprising:
a random number data generation unit that generates random number data or pseudorandom number data, and
wherein:
the generated data is random number data generated by the random number data generation unit or pseudorandom number data generated by the random number data generation unit.

35. The sound processing device according to claim 26, further comprising:
a phase information generation unit that generates phase information, and
wherein:
the adding unit adds the fourth sound data having phase information generated by the phase information generation unit to the second sound data having phase information of the first sound data.

36. The sound processing device according to claim 35, wherein:
the phase information generation unit acquires first phase information of the first sound data, and generates second phase information that differs from phase information of the first sound data, and
the adding unit adds the fourth sound data having the second phase information to the second sound data having the first phase information of the first sound data.

37. The sound processing device according to claim 26, wherein:
the adding unit changes a magnitude of the fourth sound data to be added, based on a magnitude of the noise subtracted from the first sound data.

38. The sound processing device according to claim 37, wherein:
the adding unit increases the magnitude of the fourth sound data to be added, as the magnitude of the noise subtracting from the first sound data increases.

39. The sound processing device according to claim 26, further comprising:
a frequency domain conversion unit that converts the first sound data of time domain into frequency domain; and
a reduction unit that subtracts the noise of frequency domain from the first sound data converted by the frequency domain conversion unit.

40. The sound processing device according to claim 39, wherein:
the reduction unit determines a frequency component to subtract the noise of frequency domain from the first sound data converted by the frequency domain conversion unit based on fifth sound data that does not include the noise.

41. The sound processing device according to claim 40, wherein:
the adding unit adds the fourth sound data of frequency domain to a frequency component of the first sound data converted by the frequency domain conversion unit, in which the frequency component is a component from which the noise was subtracted.

42. The sound processing device according to claim 39, further comprising:
a dividing unit that divides sound data including the first sound data into a plurality of segments, and
wherein:
the frequency domain conversion unit converts the first sound data in the plurality of segments divided by the dividing unit into frequency domain.

43. The sound processing device according to claim 39, further comprising:
a random number data generation unit that generates random number data or pseudorandom number data, and
wherein:
the frequency domain conversion unit converts, into frequency domain, second random number data produced by multiplying a window function by first random number data generated by the random number data generation unit, and
the fourth sound data is generated by correcting the second random number data converted into frequency domain based on the third sound data.

44. The sound processing device according to claim 39, farther comprising:
a time domain conversion unit that converts data into time domain, in which the data is date produced by adding the fourth sound data of frequency domain to the second sound data converted by the frequency domain conversion unit.

45. An electronic device comprising the sound processing device according to claim 26.

46. A sound processing method comprising the steps of:
reducing noise that is an object to be removed from first sound data; and
adding fourth sound data based on third sound data to second sound data produced by reducing the noise from the first sound data, and the fourth sound data is data based on third sound data, that does not include the noise.
